(19) United States
(12) Patent Application Publication
(10) Pub. No.: US 2025/0360963 A1
(43) Pub. Date: Nov. 27, 2025

(54) SIGNAL PROCESSING DEVICE AND VEHICLE CONTROL DEVICE INCLUDING THE SAME

(71) Applicant: LG ELECTRONICS INC., Seoul (KR)

(72) Inventors: Philippe Lavole, Seoul (KR); Heejun Roh, Seoul (KR); Woojin Sim, Seoul (KR)

(73) Assignee: LG ELECTRONICS INC., Seoul (KR)

(21) Appl. No.: 19/030,435

(22) Filed: Jan. 17, 2025

(30) Foreign Application Priority Data
May 24, 2024 (WO) PCT/KR2024/007068

(51) Int. Cl. B62D 15/02; B60W 30/09; G06T 7/20; G06V 20/59; G08G 1/16

(52) U.S. Cl. CPC B62D 15/0265; B60W 30/09; G06T 7/20; G06V 20/597; G08G 1/16; B60W 2420/403; B60W 2540/229; B60W 2710/207; G06T 2207/30244; G06T 2207/30261; G06T 2207/30268

(57) ABSTRACT

A signal processing device and a vehicle control device including the same according to an embodiment of the present disclosure includes a processor configured to receive a vehicle internal image from an internal camera, wherein the processor is configured to calculate a forward attention level of a driver based on the vehicle internal image, calculate a time to forward collision or a time to avoid forward collision with an object in front of a vehicle, and change a control time point of forward collision avoidance based on the forward attention level and the time to forward collision or the time to avoid forward collision. Accordingly, adaptive vehicle control may be performed according to the forward attention level of the driver.

### BACKGROUND

### 1. Technical Field

The present disclosure relates to a signal processing device and a vehicle control device including the same, and more particularly to a signal processing device capable of performing adaptive vehicle control according to a forward attention level of a driver, and a vehicle control device including the signal processing device.

### 2. Description of the Related Art

A vehicle is a machine that allows a user to move in a desired direction. A typical example of the vehicle is an automobile.

Meanwhile, a display apparatus for vehicles is mounted in the vehicle for convenience of users who use the vehicle.

The vehicle internal signal processing device receives sensor data from various vehicle internal sensor devices and processes the received sensor data for Advanced Driver Assistance System (ADAS) or autonomous driving, and the like.

European Patent No. EP3643586 as related art 1 relates to a driver assistance system (DAS) for a vehicle, in which if collision with a preceding object in a region forward of the vehicle is predicted, and if a side object located in a region on the side of the vehicle is not detected, the driver assistance system outputs a steering signal to a steering device of the vehicle.

However, related art 1 has a drawback in that the steering signal is output to the steering device of the vehicle regardless of a vehicle driver's state, such that adaptive control operation corresponding to the vehicle driver's state may not be performed.

U.S. Pat. No. 11,840,220 as related art 2 relates to a driver assistance system and a method of controlling the same, in which if there is a risk of collision with a rear vehicle, at least one of a steering system or a vehicle speed control system of the vehicle is controlled to avoid the rear vehicle.

However, related art 2 has a drawback in that the control operation to avoid the rear vehicle is performed regardless of a vehicle driver's state, such that adaptive control operation corresponding to the vehicle driver's state may not be performed.

### SUMMARY

It is an objective of the present disclosure to provide a signal processing device capable of performing adaptive vehicle control according to a forward attention level of a driver, and a vehicle control device including the signal processing device.

Meanwhile, it is another objective of the present disclosure to provide a signal processing device capable of adaptively outputting an alert message according to a forward attention level of a driver, and a vehicle control device including the signal processing device.

Meanwhile, it is yet another objective of the present disclosure to provide a signal processing device capable of providing effective vehicle control by using microservices, and a vehicle control device including the signal processing device.

In accordance with an aspect of the present disclosure, the above and other objectives can be accomplished by providing a signal processing device and a vehicle control device including the same, which include a processor configured to receive a vehicle internal image from an internal camera, wherein the processor is configured to calculate a forward attention level of a driver based on the vehicle internal image, calculate a time to forward collision or a time to avoid forward collision with an object in front of a vehicle, and change a control time point of forward collision avoidance based on the forward attention level and the time to forward collision or the time to avoid forward collision.

Meanwhile, the processor may be configured to receive a front image from a front camera, and calculate the time to forward collision or the time to avoid forward collision with the object in front of the vehicle based on the front image.

Meanwhile, the processor may be configured to: in response to the forward attention level being a first level, set the control time point of forward collision avoidance to a first time point; and in response to the forward attention level being a second level lower than the first level, set the control time point of forward collision avoidance to a second time point before the first time point.

Meanwhile, in response to the forward attention level being a third level between the first level and the second level, the processor may be configured to set the control time point of forward collision avoidance to a third time point between the first time point and the second time point.

Meanwhile, the processor may be configured to set the control time point of forward collision avoidance to a later time point as the forward attention level increases.

Meanwhile, the processor may be configured to change an output time point of an alert message for forward collision avoidance based on the forward attention level.

Meanwhile, the processor may be configured to: in response to the forward attention level being a first level, set the output time point of the alert message for forward collision avoidance to a first output time point; and in response to the forward attention level being a second level lower than the first level, set the output time point of the alert message for forward collision avoidance to a second output time point before the first output time point.

Meanwhile, the processor may be configured to control the alert message for forward collision avoidance to be output at a later time point as the forward attention level increases.

Meanwhile, the processor may be configured to change a level of change of a steering angle for forward collision avoidance based on the forward attention level.

Meanwhile, the processor may be configured to: in response to the forward attention level being a first level, set the level of change of the steering angle for forward collision avoidance to a first predetermined level; and in response to the forward attention level being a second level lower than the first level, set the level of change of the steering angle for forward collision avoidance to a second predetermined level lower than the first predetermined level.

Meanwhile, the processor may be configured to increase the level of change of the steering angle for forward collision avoidance as the forward attention level increases.

Meanwhile, the processor may be configured to execute a driver monitoring application based on the vehicle internal image, and execute an Autonomous Emergency Steering (AES) control application based on the front image.

Meanwhile, the processor may be configured to execute an alert application for forward collision avoidance based on the vehicle internal image and the front image, wherein a safety level of the alert application may be lower than a safety level of the driver monitoring application or a safety level of the AES control application.

Meanwhile, the processor may be configured to execute a plurality of virtual machines on a hypervisor, wherein some virtual machine among the plurality of virtual machines may be configured to execute the driver monitoring application based on the vehicle internal image, and execute the AES control application based on the front image.

Meanwhile, another virtual machine among the plurality of virtual machines may be configured to execute the alert application for forward collision avoidance, wherein a safety level of the alert application may be lower than a safety level of the driver monitoring application or a safety level of the AES control application.

Meanwhile, some virtual machine among the plurality of virtual machines may be configured to execute a plurality of microservices for the AES control application based on the front image, and execute a plurality of microservices for the driver monitoring application based on the vehicle internal image.

In accordance with another aspect of the present disclosure, the above and other objectives can be accomplished by providing a signal processing device and a vehicle control device including the same, which include a processor configured to receive a vehicle internal image from an internal camera and a front image from a front camera, wherein the processor is configured to calculate a forward attention level of a driver based on the vehicle internal image, calculate a time to forward collision or a time to avoid forward collision with an object in front of a vehicle based on the front image, and change a control time point of forward collision avoidance or a level of change of a steering angle for forward collision avoidance based on the forward attention level and the time to forward collision or the time to avoid forward collision.

### BRIEF DESCRIPTION OF THE DRAWINGS

The embodiments will be described in detail with reference to the following drawings in which like reference numerals refer to like elements wherein:

FIG. 1 is a diagram illustrating an example of the exterior and interior of a vehicle;

FIG. 2 is a diagram illustrating an example of the architecture of a vehicle signal processing system;

FIG. 3A is a diagram illustrating an example of a vehicle display apparatus in a vehicle;

FIG. 3B is a diagram illustrating another example of a vehicle display apparatus in a vehicle;

FIG. 4 is an exemplary internal block diagram of the vehicle of FIG. 1;

FIGS. 5A to 5D are diagrams illustrating various examples of a vehicle control device;

FIG. 6 is an exemplary block diagram of a vehicle control device according to an embodiment of the present disclosure;

FIG. 7A is a diagram referred to in the description of a signal processing device according to an embodiment of the present disclosure;

FIG. 7B is a diagram illustrating an example of executing microservices according to an embodiment of the present disclosure;

FIG. 8 is a diagram illustrating an example of a signal processing system according to an embodiment of the present disclosure;

FIG. 9 is a diagram illustrating an example of a system driven in a signal processing device according to an embodiment of the present disclosure;

FIG. 10A is a flowchart illustrating a method of operating a signal processing device according to an embodiment of the present disclosure;

FIG. 10B is a flowchart illustrating a method of operating a signal processing device according to another embodiment of the present disclosure; and

FIGS. 11A to 15 are diagrams referred to in the description of operation of FIGS. 9 to 10B.

### DETAILED DESCRIPTION

Hereinafter, the present disclosure will be described in detail with reference to the accompanying drawings.

With respect to constituent elements used in the following description, suffixes “module” and “unit” are given only in consideration of ease in preparation of the specification, and do not have or serve different meanings. Accordingly, the suffixes “module” and “unit” may be used interchangeably.

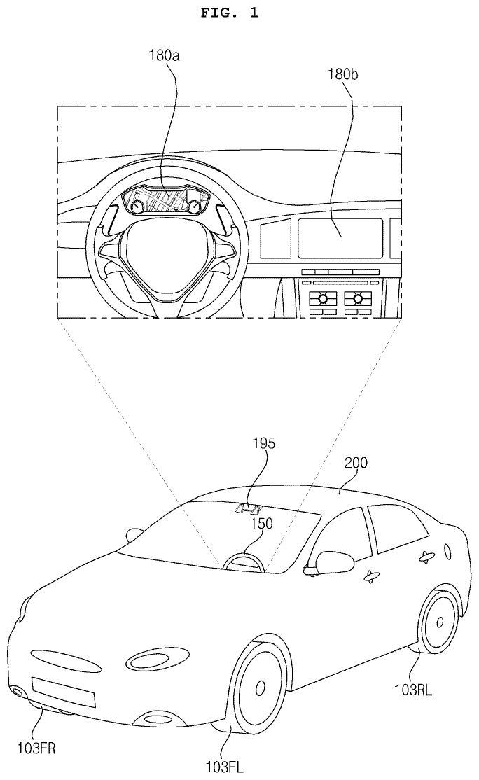

FIG. 1 is a diagram illustrating an example of the exterior and interior of a vehicle.

Referring to the figure, the vehicle 200 is moved by a plurality of wheels 103FR, 103FL, 103RL, . . . rotated by a power source and a steering wheel 150 configured to adjust an advancing direction of the vehicle 200.

Meanwhile, the vehicle 200 may be provided with a camera 195 configured to acquire an image of the front of the vehicle.

Meanwhile, the vehicle 200 may be further provided therein with a plurality of displays 180a and 180b configured to display images and information.

In FIG. 1, a cluster display 180a and an audio video navigation (AVN) display 180b are illustrated as the plurality of displays 180a and 180b. In addition, a head up display (HUD) may also be used.

Meanwhile, the audio video navigation (AVN) display 180b may also be called a center information display.

Meanwhile, the vehicle 200 described in this specification may be a concept including all of a vehicle having an engine as a power source, a hybrid vehicle having an engine and an electric motor as a power source, and an electric vehicle having an electric motor as a power source.

FIG. 2 is a diagram illustrating an example of the architecture of a vehicle signal processing system.

Referring to the figure, an architecture 300a of a vehicle signal processing system may correspond to a zone-based architecture.

Accordingly, vehicle internal sensor devices and processors may be mounted in each of a plurality of zones Z1 to Z4, and a signal processing device 170a including a vehicle communication gateway GWDa may be disposed at the center of the plurality of zones Z1 to Z4.

Meanwhile, the signal processing device 170a may further include an autonomous driving control module ACC, a cockpit control module CPG, etc., in addition to the vehicle communication gateway GWDa.

The vehicle communication gateway GWDa in the signal processing device 170a may be a High Performance Computing (HPC) gateway.

That is, as an integrated HPC gateway, the signal processing device 170a of FIG. 2 may exchange data with an external communication module (not shown) or processors (not shown) in the plurality of zones Z1 to Z4.

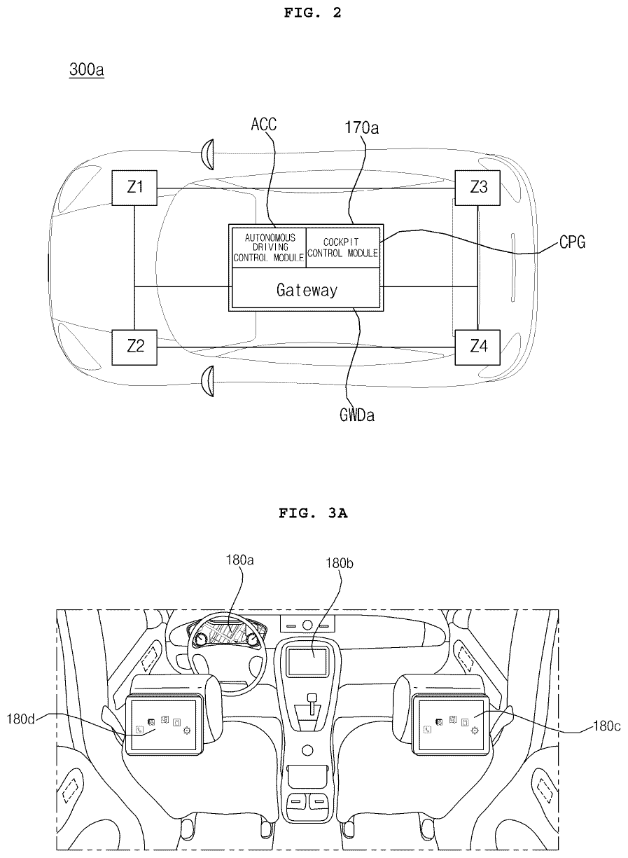

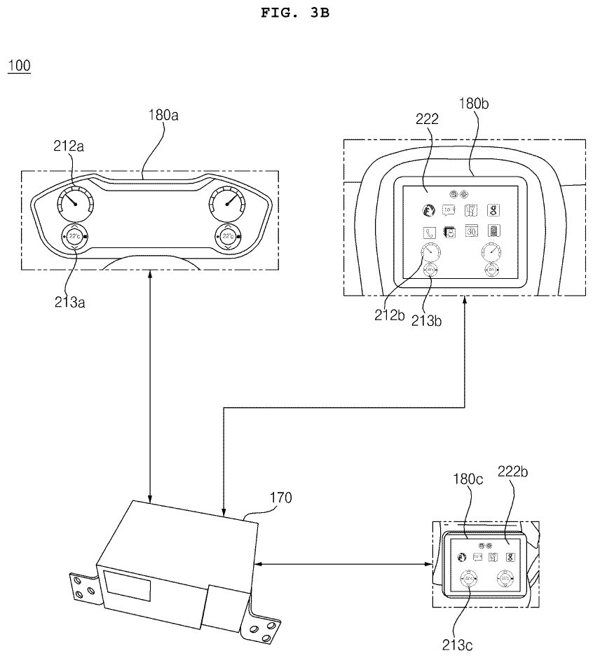

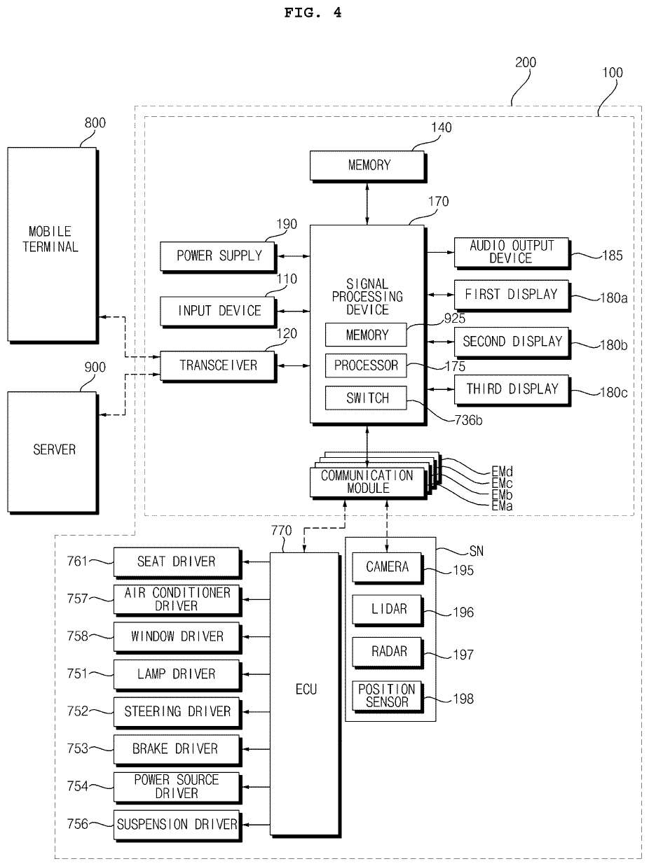

FIG. 3A is a diagram illustrating an example of a vehicle display apparatus in a vehicle.

Referring to the figure, a cluster display 180a, an audio video navigation (AVN) display 180b, rear seat entertainment displays 180c and 180d, and a rear-view mirror display (not shown) may be mounted in the vehicle.

FIG. 3B is a diagram illustrating another example of a vehicle display apparatus in a vehicle.

A vehicle display apparatus 100 according to the embodiment of the present disclosure may include a plurality of displays 180a and 180b and a signal processing device 170 configured to perform signal processing in order to display images and information on the plurality of displays 180a and 180b, and to output an image signal to at least one of the displays 180a and 180b.

The first display 180a, which is one of the plurality of displays 180a and 180b, may be a cluster display 180a configured to display a driving state and operation information, and the second display 180b may be an audio video navigation (AVN) display 180b configured to display vehicle driving information, a navigation map, various kinds of entertainment information, or an image.

The signal processing device 170 may have a processor 175 provided therein, and first to third virtual machines (not shown) may be executed by a hypervisor 505 in the processor 175.

The second virtual machine (not shown) may be operated for the first display 180a, and the third virtual machine (not shown) may be operated for the second display 180b.

Meanwhile, the first virtual machine (not shown) in the processor 175 may be configured to set a shared memory 508 based on the hypervisor 505 for transmission of the same data to the second virtual machine (not shown) and the third virtual machine (not shown). Consequently, the first display 180a and the second display 180b in the vehicle may display the same information or the same images in a synchronized state.

Meanwhile, the first virtual machine (not shown) in the processor 175 shares at least some of data with the second virtual machine (not shown) and the third virtual machine (not shown) for divided processing of data. Consequently, the plurality of virtual machines for the plurality of displays in the vehicle may divide and process data.

Meanwhile, the first virtual machine (not shown) in the processor 175 may receive and process wheel speed sensor data of the vehicle, and may transmit the processed wheel speed sensor data to at least one of the second virtual machine (not shown) or the third virtual machine (not shown). Consequently, at least one virtual machine may share the wheel speed sensor data of the vehicle.

Meanwhile, the vehicle display apparatus 100 according to the embodiment of the present disclosure may further include a rear seat entertainment (RSE) display 180c configured to display driving state information, simple navigation information, various kinds of entertainment information, or an image.

The signal processing device 170 may further execute a fourth virtual machine (not shown), in addition to the first to third virtual machines (not shown), on the hypervisor 505 in the processor 175 to control the RSE display 180c.

Consequently, it is possible to control various displays 180a to 180c using a single signal processing device 170.

Meanwhile, some of the plurality of displays 180a to 180c may be operated based on a Linux Operating System (OS), and others may be operated based on a Web Operating System (OS).

The signal processing device 170 according to the embodiment of the present disclosure may be configured to display the same information or the same images in a synchronized state on the displays 180a to 180c to be operated under various operating systems.

Meanwhile, FIG. 3B illustrates an example in which a vehicle speed indicator 212a and a vehicle internal temperature indicator 213a are displayed on a first display 180a, a home screen 222 including a plurality of applications, a vehicle speed indicator 212b, and a vehicle internal temperature indicator 213b is displayed on a second display 180b, and a second home screen 222b including a plurality of applications and a vehicle internal temperature indicator 213c is displayed on a third display 180c.

FIG. 4 is an exemplary internal block diagram of the vehicle of FIG. 1.

Referring to the figure, the vehicle 200 according to an embodiment of the present disclosure may include a lamp driver 751, a steering driver 752, a brake driver 753, a power source driver 754, a suspension driver 756, an air conditioner driver 755, a window driver 758, a seat driver 761, and the signal processing device 170.

Meanwhile, the vehicle 200 may further include an ECU 770, a plurality of sensor devices SN, and a plurality of communication modules EMa to EMd.

Meanwhile, the vehicle 200 according to an embodiment of the present disclosure may further include the vehicle display apparatus 100.

Referring to the figure, the vehicle display apparatus 100 according to the embodiment of the present disclosure may include an input device 110, a transceiver 120 for communication with an external device, the plurality of communication modules EMa to EMd for internal communication, a memory 140, the signal processing device 170, a plurality of displays 180a to 180c, an audio output device 185, and a power supply 190.

The plurality of communication modules EMa to EMd may be disposed in a plurality of zones Z1 to Z4, respectively, in FIG. 2.

Meanwhile, the signal processing device 170 may be provided therein with a communication switch 736b for data communication with the respective communication modules EM1 to EM4.

The respective communication modules EM1 to EM4 may perform data communication with the plurality of sensor devices SN or the ECU 770.

Meanwhile, each of the plurality of sensor devices SN may include a camera 195, a lidar sensor 196, a radar sensor 197, or a position sensor 198.

The input device 110 may include a physical button or pad for button input or touch input.

Meanwhile, the input device 110 may include a microphone (not shown) for user voice input.

The transceiver 120 may wirelessly exchange data with a mobile terminal 800 or a server 900.

In particular, the transceiver 120 may wirelessly exchange data with a mobile terminal of a vehicle driver. Any of various data communication schemes, such as Bluetooth, Wi-Fi, WIFI Direct, and APIX, may be used as a wireless data communication scheme.

The transceiver 120 may receive weather information and road traffic state information, such as Transport Protocol Experts Group (TPEG) information, from a mobile terminal 800 or a server 900. To this end, the transceiver 120 may include a mobile communication module (not shown).

The plurality of communication modules EM1 to EM4 may receive sensor data and the like from the electronic control unit (ECU) 770 or the sensor device SN or a zonal signal processing device 170Z, and may transmit the received sensor data to the signal processing device 170.

Here, the sensor data may include at least one of vehicle direction data, vehicle position data (global positioning system (GPS) data), vehicle angle data, vehicle speed data, vehicle acceleration data, vehicle inclination data, vehicle forward/backward movement data, battery data, fuel data, tire data, vehicle lamp data, vehicle internal temperature data, and vehicle internal humidity data.

The sensor data may be acquired from a heading sensor, a yaw sensor, a gyro sensor, a position sensor, a vehicle forward/backward movement sensor, a wheel sensor, a vehicle speed sensor, a car body inclination sensor, a battery sensor, a fuel sensor, a tire sensor, a steering-wheel-rotation-based steering sensor, a vehicle internal temperature sensor, or a vehicle internal humidity sensor.

Meanwhile, the position module may include a GPS module configured to receive GPS information or a position sensor 198.

Meanwhile, at least one of the plurality of communication modules bEM1 to EM4 may transmit position information data sensed by the GPS module or the position sensor 198 to the signal processing device 170.

Meanwhile, at least one of the plurality of communication modules EM1 to EM4 may receive front image data of the vehicle, side-of-vehicle image data, rear image data of the vehicle, and obstacle-around-vehicle distance information from the camera 195, the lidar sensor 196, or the radar sensor 197, and may transmit the received information to the signal processing device 170.

The memory 140 may store various data necessary for overall operation of the vehicle display apparatus 100, such as programs for processing or control of the signal processing device 170.

For example, the memory 140 may store data about the hypervisor and first to third virtual machines executed by the hypervisor in the processor 175.

The audio output device 185 may convert an electrical signal from the signal processing device 170 into an audio signal, and may output the audio signal. To this end, the audio output device 185 may include a speaker.

The power supply 190 may supply power necessary to operate components under control of the signal processing device 170. In particular, the power supply 190 may receive power from a battery in the vehicle.

The signal processing device 170 may control the overall operation of each device in the vehicle display apparatus 100 or the vehicle 200.

For example, the signal processing device 170 may include a processor 175 configured to perform signal processing for the vehicle displays 180a and 180b.

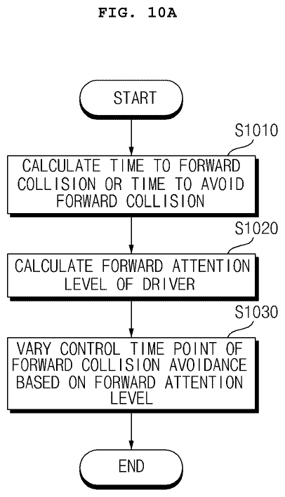

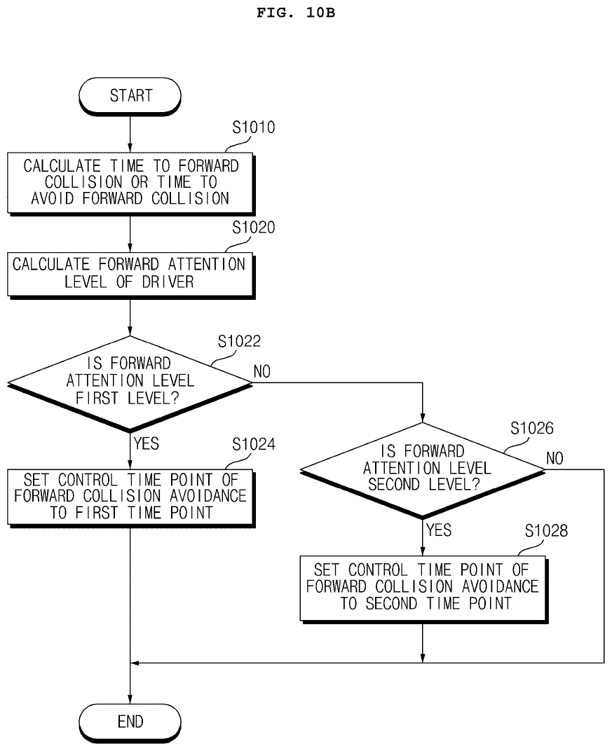

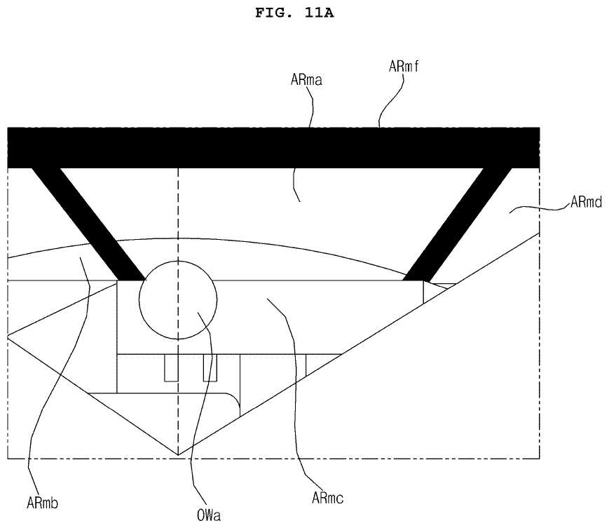

The processor 175 may execute the first to third virtual machines (not shown) on the hypervisor 505 (see FIG. 10) in the processor 175.

Among the first to third virtual machines (not shown) (see FIG. 10), the first virtual machine (not shown) may be called a server virtual machine, and the second and third virtual machines (not shown) and (not shown) may be called guest virtual machines.

For example, the first virtual machine (not shown) in the processor 175 may receive sensor data from the plurality of sensor devices, such as vehicle sensor data, position information data, camera image data, audio data, or touch input data, and may process and output the received sensor data.

As described above, the first virtual machine (not shown) may process most of the data, whereby 1:N data sharing may be achieved.

In another example, the first virtual machine (not shown) may directly receive and process CAN data, Ethernet data, audio data, radio data, USB data, and wireless communication data for the second and third virtual machines (not shown).

Further, the first virtual machine (not shown) may transmit the processed data to the second and third virtual machines (not shown).

Accordingly, only the first virtual machine (not shown), among the first to third virtual machines (not shown), may receive sensor data from the plurality of sensor devices, communication data, or external input data, and may perform signal processing, whereby load in signal processing by the other virtual machines may be reduced and 1:N data communication may be achieved, and therefore synchronization at the time of data sharing may be achieved.

Meanwhile, the first virtual machine (not shown) may be configured to write data in the shared memory 508, whereby the second virtual machine (not shown) and the third virtual machine (not shown) share the same data.

For example, the first virtual machine (not shown) may be configured to write vehicle sensor data, the position information data, the camera image data, or the touch input data in the shared memory 508, whereby the second virtual machine (not shown) and the third virtual machine (not shown) share the same data. Consequently, 1:N data sharing may be achieved.

Eventually, the first virtual machine (not shown) may process most of the data, whereby 1:N data sharing may be achieved.

Meanwhile, the first virtual machine (not shown) in the processor 175 may be configured to set the shared memory 508 based on the hypervisor 505 in order to transmit the same data to the second virtual machine (not shown) and the third virtual machine (not shown).

Meanwhile, the signal processing device 170 may process various signals, such as an audio signal, an image signal, and a data signal. To this end, the signal processing device 170 may be implemented in the form of a system on chip (SOC).

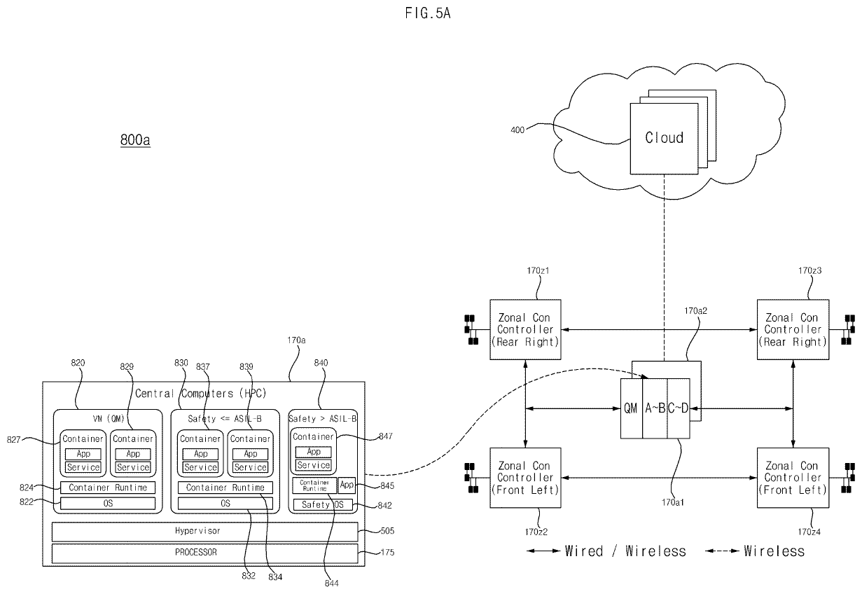

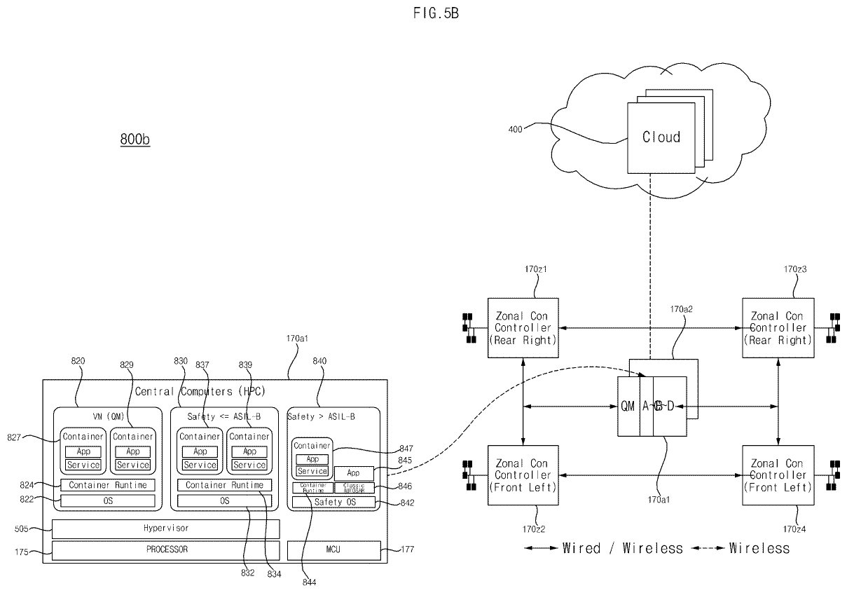

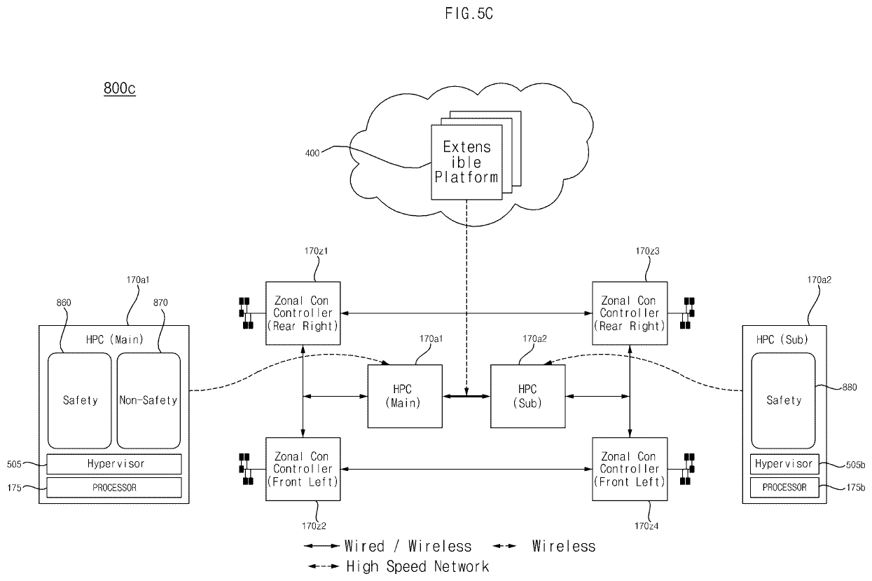

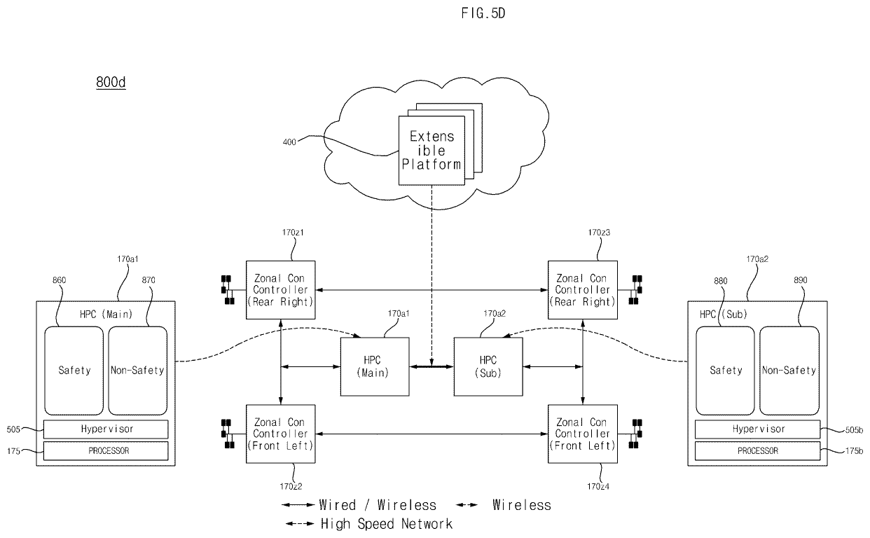

Meanwhile, the signal processing device 170 of FIG. 4 may be the same as signal processing devices 170, 170al, and 170a2 of a vehicle control device of FIG. 5A and subsequent figures.

FIGS. 5A to 5D are diagrams illustrating various examples of a vehicle control device.

FIG. 5A is a diagram illustrating an example of a vehicle control device according to an embodiment of the present disclosure.

Referring to the figure, a vehicle control device 800a according to an embodiment of the present disclosure includes signal processing devices 170a1 and 170a2.

Meanwhile, the vehicle control device 800a according to an embodiment of the present disclosure may further include a plurality of zonal signal processing devices 170Z1 to 170Z4. Meanwhile, two signal processing devices 170a1 and 170a2 are illustrated in the figure, which are provided for backup and the like, and one signal processing device is also possible.

Meanwhile, the signal processing devices 170al and 170a2 may be referred to as a High Performance Computing (HPC) signal processing devices.

The plurality of zonal signal processing devices 170Z1 to 170Z4 may be located in the respective zones Z1 to Z4 and may transmit sensor data to the signal processing devices 170al and 170a2.

The signal processing devices 170al and 170a2 may receive data by wire from the plurality of zonal signal processing devices 170Z1 to 17024 or a communication device 120.

In the drawing, an example is illustrated in which the signal processing devices 170al and 170a2 exchange data with the plurality of zonal signal processing devices 170z1 to 170z4 based on wired communication, and the signal processing devices 170a1 and 170a2 exchange data with the server 400 based on wireless communication, but the communication device 120 may exchange data with the server 400 based on wireless communication, and the signal processing devices 170al and 170a2 may exchange data with the communication device 120 based on wired communication.

Meanwhile, the data received by the signal processing devices 170al and 170a2 may include camera data or sensor data.

For example, the vehicle internal sensor data may include at least one of vehicle wheel speed data, vehicle direction data, vehicle location data (global positioning system (GPS) data), vehicle angle data, vehicle speed data, vehicle acceleration data, vehicle inclination data, vehicle forward/backward movement data, battery data, fuel data, tire data, vehicle lamp data, vehicle internal temperature data, vehicle internal humidity data, external vehicle radar data, and external vehicle lidar data.

Meanwhile, the camera data may include external vehicle camera data and vehicle internal camera data.

Meanwhile, the signal processing devices 170a1 and 170a2 may execute a plurality of virtual machines 820, 830, and 840 based on safety levels.

In the drawing, an example is illustrated in which the processor 175 in the signal processing device 170a executes the hypervisor 505, and executes first to third virtual machines 820 to 840 on the hypervisor 505 according to the Automotive Safety Integrity Level (ASIL).

The first virtual machine 820 may be a virtual machine corresponding to quality management (QM) which is the lowest risk level of the ASIL with no mandatory need.

The first virtual machine 820 may execute an operating system 822, a container runtime 824 on the operating system 822, and containers 827 and 829 on the container runtime 824.

The second virtual machine 820 may be a virtual machine corresponding to ASIL A or ASIL B with the combination of severity, exposure, and controllability values being 7 or 8.

The second virtual machine 820 may execute an operating system 832, a container runtime 834 on the operating system 832, and containers 837 and 839 on the container runtime 834.

The third virtual machine 840 may be a virtual machine corresponding to ASIL C or ASIL D with the combination of severity, exposure, and controllability values being 9 or 10.

Meanwhile, ASIL D may correspond to a grade that requires the highest level of safety.

The third virtual machine 840 may execute a safety operating system 842 and an application 845 on the operating system 842.

Meanwhile, the third virtual machine 840 may also execute the safety operating system 842, a container runtime 844 on the safety operating system 842, and a container 847 on the container runtime 844.

Meanwhile, unlike the drawing, the third virtual machine 840 may also be executed by a separate core, rather than by the processor 175, which will be described below with reference to FIG. 5B.

FIG. 5B is a diagram illustrating another example of a vehicle control device according to an embodiment of the present disclosure.

Referring to the figure, a vehicle control device 800b according to an embodiment of the present disclosure includes the signal processing devices 170a1 and 170a2.

Meanwhile, the vehicle control device 800b according to an embodiment of the present disclosure may further include a plurality of zonal signal processing devices 170Z1 to 170Z4.

The vehicle control device 800b of FIG. 5B is similar to the vehicle control device 800a of FIG. 5A, with a difference being that the signal processing device 170al of FIG. 5B is partially different from the signal processing device 170al of FIG. 5A.

The following description will focus on the difference, in which the signal processing device 170a may include a processor 175 and a second processor 177.

The processor 175 in the signal processing device 170a1 executes the hypervisor 505, and executes the first and second virtual machines 820 and 830 on the hypervisor 505 according to the ASIL.

The first virtual machine 820 may execute the operating system 822, the container runtime 824 on the operating system 822, and the containers 827 and 829 on the container runtime 824.

The second virtual machine 820 may execute the operating system 832, the container runtime 834 on the operating system 832, and the containers 837 and 839 on the container runtime 834.

Meanwhile, the second processor 177 in the signal processing device 170al may execute the third virtual machine 840.

The third virtual machine 840 may execute the safety operating system 842, an AUTOSAR 845 on the operating system 842, and an application 845 on the AUTOSAR 845. That is, unlike FIG. 5A, the third virtual machine 840 may further execute the AUTOSAR 846 on the operating system 842.

Meanwhile, similarly to FIG. 5A, the third virtual machine 840 may also execute the safety operating system 842, the container runtime 844 on the safety operating system 842, and the container 847 on the container runtime 844.

Meanwhile, unlike the first and second virtual machines 820 and 830, the third virtual machine 840 that requires a high safety level is desirably executed by the second processor 177 that is a different core or a different processor.

Meanwhile, in the signal processing devices 170a1 and 170a2 of FIGS. 5A and 5B, if there is abnormality in the first signal processing device 170a, the second signal processing device 170a may operate which is provided for backup purposes.

Unlike the example, the signal processing devices 170al and 170a2 may operate at the same time, among which the first signal processing device 170a may operate as a main device, and the second signal processing device 170a2 may operate as a sub device, which will be described below with reference to FIGS. 5C and 5D.

FIG. 5C is a diagram illustrating yet another example of a vehicle control device according to an embodiment of the present disclosure.

Referring to the figure, a vehicle control device 800c according to an embodiment of the present disclosure includes the signal processing devices 170al and 170a2.

Meanwhile, the vehicle control device 800c according to an embodiment of the present disclosure may further include a plurality of zonal signal processing devices 170Z1 to 170Z4.

Meanwhile, two signal processing devices 170al and 170a2 are illustrated in the figure, which are provided for backup and the like, and one signal processing device is also possible.

Meanwhile, the signal processing devices 170al and 170a2 may be referred to as a High Performance Computing (HPC) signal processing devices.

The plurality of zonal signal processing devices 170Z1 to 170Z4 may be located in the respective zones Z1 to Z4 and may transmit sensor data to the signal processing devices 170al and 170a2.

The signal processing devices 170al and 170a2 may receive data by wire from the plurality of zonal signal processing devices 170Z1 to 17024 or a communication device 120.

In the drawing, an example is illustrated in which the signal processing devices 170al and 170a2 exchange data with the plurality of zonal signal processing devices 170Z1 to 170z4 based on wired communication, and the signal processing devices 170al and 170a2 exchange data with the server 400 based on wireless communication, but the communication device 120 may exchange data with server the 400 based on wireless communication, and the signal processing devices 170al and 170a2 exchange data with the communication device 120 based on wired communication.

Meanwhile, the data received by the signal processing devices 170a1 and 170a2 may include camera data or sensor data.

Meanwhile, the processor 175 in the first signal processing device 170al of the signal processing devices 170a1 and 170a2 may execute the hypervisor 505, and may execute each of a safety virtual machine 860 and a non safety virtual machine 870 on the hypervisor 505.

Meanwhile, the processor 175b in the second signal processing device 170a2 of the signal processing devices 170a1 and 170a2 may execute the hypervisor 505b, and may execute only a safety virtual machine 880 on the hypervisor 505.

In the method, safety and non safety virtual machines may be processed separately by the first signal processing device 170al and the second signal processing device 170a2, thereby improving stability and processing speed.

Meanwhile, high-speed network communication may be performed between the first signal processing device 170al and the second signal processing device 170a2.

FIG. 5D is a diagram illustrating yet another example of a vehicle control device according to an embodiment of the present disclosure.

Referring to the figure, a vehicle control device 800d according to an embodiment of the present disclosure includes the signal processing devices 170a1 and 170a2.

Meanwhile, the vehicle control device 800d according to an embodiment of the present disclosure may further include the plurality of zonal signal processing devices 170Z1 to 170Z4.

The vehicle control device 800d of FIG. 5D is similar to the vehicle control device 800c of FIG. 5C, with a difference being that the second signal processing device 170a2 of FIG. 5D is partially different from the second signal processing device 170a2 of FIG. 5C.

The processor 175b in the second signal processing device 170a2 of FIG. 5D may execute the hypervisor 505b, and may execute each of a safety virtual machine 880 and a non safety virtual machine 890 on the hypervisor 505.

That is, unlike FIG. 5C, there is a difference in that the processor 175b in the second signal processing device 170a2 further executes the non safety virtual machine 890.

In the method, safety and non safety virtual machines may be processed separately by the first signal processing device 170al and the second signal processing device 170a2, thereby improving stability and processing speed.

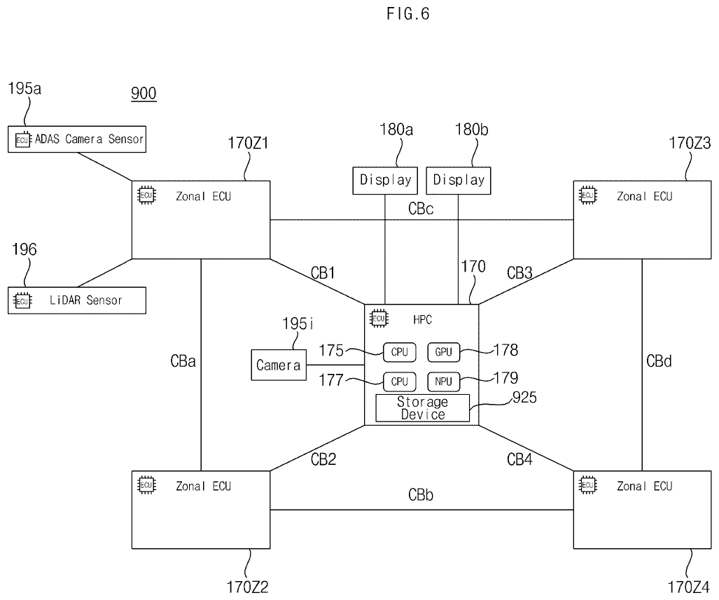

FIG. 6 is an exemplary block diagram of a vehicle control device according to an embodiment of the present disclosure.

Referring to the figure, a vehicle control device 900 according to an embodiment of the present disclosure includes the signal processing device 170.

The vehicle control device 900 according to an embodiment of the present disclosure may further include at least one display.

Meanwhile, the vehicle control device 900 according to an embodiment of the present disclosure may further include the steering driver 752, the brake driver 753, and the power source driver 754, the ECU 770, the plurality of sensor devices SN, or the like of FIG. 4.

Meanwhile, the vehicle control device 900 according to an embodiment of the present disclosure may further include the lamp driver 751, the suspension driver 756, the air conditioner driver 755, the window driver 758, and the seat driver 761, the plurality of communication modules EMa to EMd, or the like of FIG. 4.

In the drawing, the cluster display 180a and the AVN display 180b are illustrated as at least one display.

Meanwhile, the vehicle control device 900 may further include the plurality of zonal signal processing devices 170Z1 to 170Z4.

In this case, the signal processing device 170 is a high-performance centralized signal processing and control device including a plurality of CPUs 175, GPUS 178, NPUs 179, etc., and may be referred to as a High Performance Computing (HPC) signal processing device or a central signal processing device.

The plurality of zonal signal processing devices 170Z1 to 170Z4 and the signal processing device 170 may be connected via wired cables CB1 to CB4.

Meanwhile, the plurality of zonal signal processing devices 170Z1 to 170Z4 may be connected via wired cables CBa to CBd.

In this case, the wired cables CBa to CBd may include CAN communication cable or Ethernet communication cable, or PCI Express cable.

Meanwhile, the signal processing device 170 according to an embodiment of the present disclosure may include at least one processor 175, 178, and 177, and a storage device 925 having a large capacity.

For example, the signal processing device 170 according to an embodiment of the present disclosure may include central processors 175 and 177, a graphic processor 178, and a neural processor 179.

Meanwhile, sensor data may be transmitted from at least one of the plurality of zonal signal processing devices 170Z1 to 170Z4 to the signal processing device 170. Particularly, the sensor data may be stored in the storage device 925 in the signal processing device 170.

In this case, the sensor data may include at least one of camera data, lidar data, radar data, vehicle direction data, vehicle position data (global positioning system (GPS) data), vehicle angle data, vehicle speed data, vehicle acceleration data, vehicle inclination data, vehicle forward/backward movement data, battery data, fuel data, tire data, vehicle lamp data, vehicle internal temperature data, and vehicle internal humidity data.

In the drawing, an example is illustrated in which the camera data from the camera 195a and the lidar data from the lidar sensor 196 are input to a first zonal signal processing device 17021, and the camera data and the lidar data are transmitted to the signal processing device 170 via a second zonal signal processing device 17022 and a third zonal signal processing device 17023, and the like.

Meanwhile, data write speed or data read speed to write and read data to and from the storage device 925 is faster than a network speed when the sensor data is transmitted from at least one of the plurality of zonal signal processing devices 170Z1 to 17024 to the signal processing device 170, such that it is preferred to perform multi path routing so as to avoid bottlenecks in a network.

To this end, the signal processing device 170 according to an embodiment of the present disclosure may perform multi path routing based on Software Defined Network (SDN). Accordingly, stable network environment for data write and read operations may be ensured. Further, data may be transmitted to the storage device 925 by using multiple paths, such that data may be transmitted by dynamically changing a network configuration.

It is desirable that data communication between the plurality of zonal signal processing devices 170Z1 to 17024 and the signal processing device 170 in the vehicle control device 900 according to an embodiment of the present disclosure is peripheral component interconnect express communication in order to provide high band and low delay communication.

Meanwhile, the signal processing device 170 according to an embodiment of the present disclosure may receive a vehicle internal image from an internal camera 195i, and may perform signal processing on the vehicle internal image.

Meanwhile, the signal processing device 170 according to an embodiment of the present disclosure may receive a front image from a front camera 195a, and may perform signal processing on the front image.

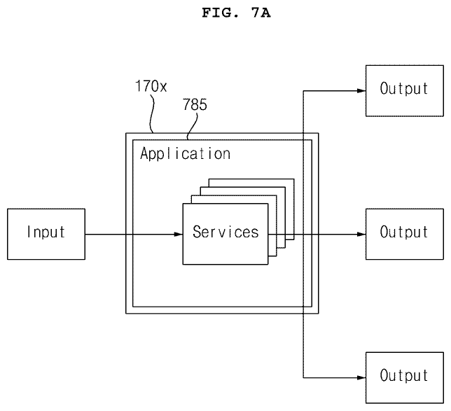

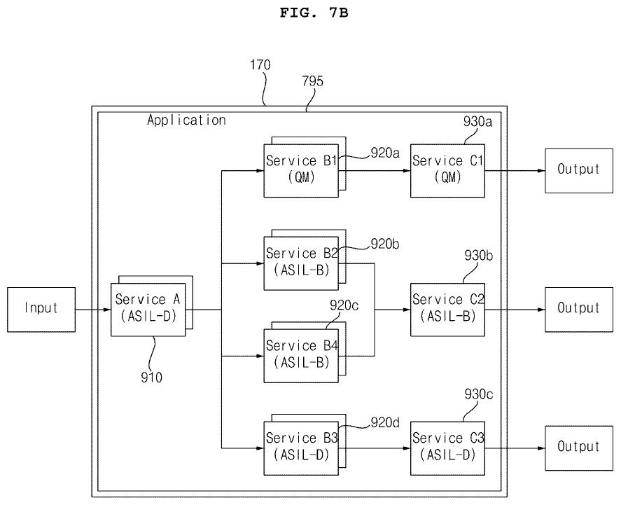

FIG. 7A is a diagram referred to in the description of a signal processing device related to the present disclosure.

Referring to the figure, a signal processing device 170x related to the present disclosure executes an application 785 based on sensor data or camera data and the like of a vehicle, and may output result data of the application 785 via multiple paths.

In the method, the result data of the application 785 is output after execution of the application 785 is completed, such that inefficiency occurs until execution of the application 785 is completed, thereby increasing the possibility that it takes a considerable amount of time.

Accordingly, the present disclosure proposes a scheme for sharing intermediate result data of an application during execution of the application.

To this end, the signal processing device 170 according to an embodiment of the present disclosure splits an application into a plurality of microservices, and executes different microservices based on results of microservices, thereby efficiently offloading workload.

FIG. 7B is a diagram illustrating an example of executing a microservice according to an embodiment of the present disclosure.

Referring to the figure, the signal processing device 170 according to an embodiment of the present disclosure may execute an application 795 based on sensor data or camera data and the like of a vehicle.

In this case, the signal processing device 170 according to an embodiment of the present disclosure may separately execute the plurality of microservices for the application 795.

Meanwhile, the signal processing device 170 according to an embodiment of the present disclosure may separately execute an application or microservices for each safety level.

In this case, when a safety level of a transmission application or microservice is higher than or equal to a safety level of a reception application or microservice, the signal processing device 170 according to an embodiment of the present disclosure transmits result data of the transmission application or microservice.

Meanwhile, in the case in which the safety level of the transmission application or microservice is lower than or equal to the safety level of the reception application or microservice, the signal processing device 170 according to an embodiment of the present disclosure does not transmit result data of the transmission application or microservice.

In the drawing, a first microservice 910 corresponding to ASIL D which is a second safety level, is executed based on input data, and result data of the first microservice 910 corresponding to ASIL D may be transmitted to each of a second microservice 920a corresponding to QM which is a third safety level, a third microservice 920b corresponding to ASIL B which is a first safety level, a fourth microservice 920c corresponding to ASIL B which is the first safety level, and a fifth microservice 920d corresponding to ASIL D which is the third safety level.

As the safety level of the first microservice 910 is higher than the safety levels of the second microservice 920a, the third microservice 920b, and the fourth microservice 920c, such that result data of the first microservice 910 may be transmitted.

Meanwhile, as the safety level of the first microservice 910 is equal to the safety level of the fifth microservice 920d, such that result data of the first microservice 910 may be transmitted.

Then, a sixth microservice 930a corresponding to QM which is the third safety level is executed based on result data of the second microservice 920a, and result data thereof may be output via a first path.

Meanwhile, a seventh microservice 930b corresponding to ASIL B which is the first safety level is executed based on result data of the third microservice 920a and result data of the fourth microservice 920c, and result data thereof may be output via a second path.

Meanwhile, an eighth microservice 930c corresponding to ASIL D which is the second safety level is executed based on result data of the fifth microservice 920d, and result data thereof may be output via a third path.

As illustrated herein, in addition to outputting result data of the application 795 via multiple paths, corresponding microservices are executed via the respective paths in the signal processing device 170 unlike FIG. 7A, thereby efficiently offloading workload, and allowing efficient data processing.

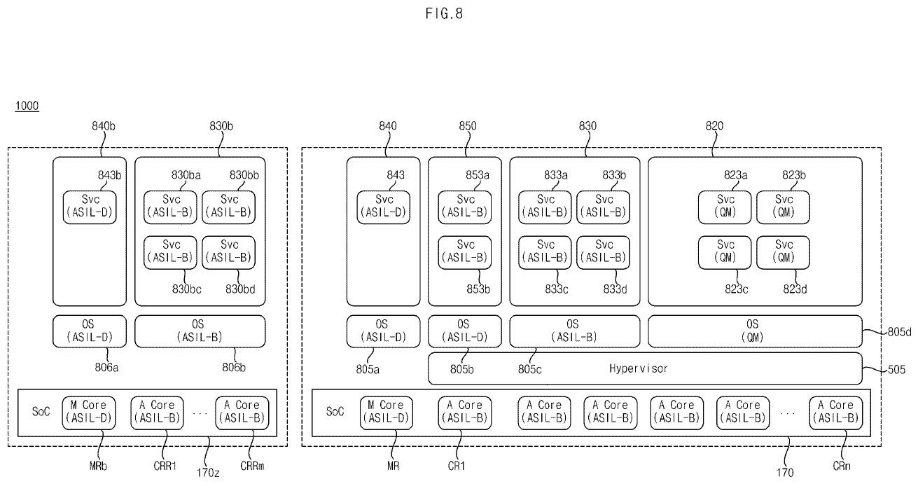

FIG. 8 is a diagram illustrating an example of a signal processing system according to an embodiment of the present disclosure.

Referring to the figure, a signal processing system 1000 according to an embodiment of the present disclosure may include a central signal processing device 170 and a zonal signal processing device 170z.

Meanwhile, the signal processing device 170 in the system 1000 according to an embodiment of the present disclosure includes a plurality of processor cores CR1 to CRn and MR.

Meanwhile, some processor cores CR1 to CRn among the plurality of processor cores CR1 to CRn and MR may correspond to processor cores in the central processor CPU of FIG. 6.

For example, some processor cores CR1 to CRn among the plurality of processor cores CR1 to CRn and MR may correspond to application processor cores in the central processor CPU of FIG. 6.

Meanwhile, some processor cores CR1 to CRn among the plurality of processor cores CR1 to CRn and MR may operate based on the hypervisor 505, and the hypervisor 505 may execute the plurality of virtual machines 820 to 850.

Meanwhile, another processor core MR among the plurality of processor cores CR1 to CRn and MR may correspond to M core or micom unit (MCU).

Meanwhile, another processor core MR among the plurality of processor cores CR1 to CRn and MR may execute an operating system 805a corresponding to the second safety level such as ASIL D, without executing the hypervisor 505, and may execute a fourth virtual machine 840 on the operating system 805a.

Meanwhile, the fourth virtual machine 840 may execute an application corresponding to the second safety level such as ASIL D or a microservice 843 corresponding to the application corresponding to the second safety level. Accordingly, the microservice 843 or the application corresponding to the second safety level may be stably executed.

Meanwhile, a first processor core CR1 among the plurality of processor cores CR1 to CRn and MR may execute the hypervisor 505, may execute the operating system 805b, corresponding to the second safety level such as ASIL D, on the hypervisor 505, and may execute the first virtual machine 850 on the operating system 805b.

Meanwhile, the first virtual machine 850 may execute an application corresponding to the first safety level such as ASIL B or microservices 853a and 853b corresponding to the application corresponding to the first safety level.

Accordingly, the microservices 853a and 853b or the application corresponding to the first level safety may be stably executed.

Meanwhile, unlike the drawing, the first processor core CR1 among the plurality of processor cores CR1 to CRn and MR may execute an operating system, corresponding to the first safety level such as ASIL B, on the hypervisor 505.

Meanwhile, the second processor core CR2 and the third processor core CR3 among the plurality of processor cores CR1 to CRn and MR may execute the hypervisor 505, may execute the operating system 805c, corresponding to the first safety level such as ASIL B, on the hypervisor 505, and may execute the second virtual machine 850 on the operating system 805c.

Meanwhile, the second virtual machine 850 may execute a third application corresponding to the first safety level such as ASIL B or microservices 833a to 833d corresponding to the third application corresponding to the first safety level. Accordingly, the microservices 833a to 833d or the application corresponding to the first safety level may be stably executed.

Meanwhile, the remaining processor cores CR4 to CRn among the plurality of processor cores CR1 to CRn and MR may execute the hypervisor 505, may execute the operating system 805d, corresponding to the third safety level such as QM, on the hypervisor 505, and may execute the third virtual machine 820 on the operating system 805d.

Meanwhile, the third virtual machine 820 may execute a fourth application corresponding to the third safety level such as QM or microservices 823a to 823d corresponding to the fourth application corresponding to the third safety level, on the operating system 805d that corresponds to the third safety level lower than the first safety level. Accordingly, the microservices 823a to 823d or the application corresponding to the third safety level may be stably executed.

Meanwhile, the zonal signal processing device 170z may include a plurality of application processor cores CRR1 to CRRm, and an M-core MRb for executing an application corresponding to the second safety level, such as ASIL D, which is the highest level of safety.

Meanwhile, some processor cores RR1 to CRRm among the plurality of processor cores CRR1 to CRRm in the zonal signal processing device 170z may execute an operating system 806b corresponding to the first safety level such as ASIL B, and may execute the virtual machine 830b, corresponding to the first safety level, on the operating system 806a.

Meanwhile, the virtual machine 830b corresponding to the first safety level may execute the application corresponding to the first safety level such as ASIL B, or microservices 830ba to 830bd corresponding to the application corresponding to the first safety level. Accordingly, the microservices 830ba to 830bd or the application corresponding to the first safety level may be stably executed.

Meanwhile, another processor core MRb among the plurality of processor cores CRR1 to CRRm and MRb in the zonal signal processing device 170z may execute an operating system 806a corresponding to the second safety level such as ASIL D, and may execute the virtual machine 840b, corresponding to the second safety level such as ASIL D, on the operating system 806a.

Meanwhile, the virtual machine 840b corresponding to the second safety level may execute the application corresponding to the second safety level such as ASIL D, or a microservice 843b corresponding to the application corresponding to the second safety level. Accordingly, the microservice 843b or the application corresponding to the second safety level may be stably executed.

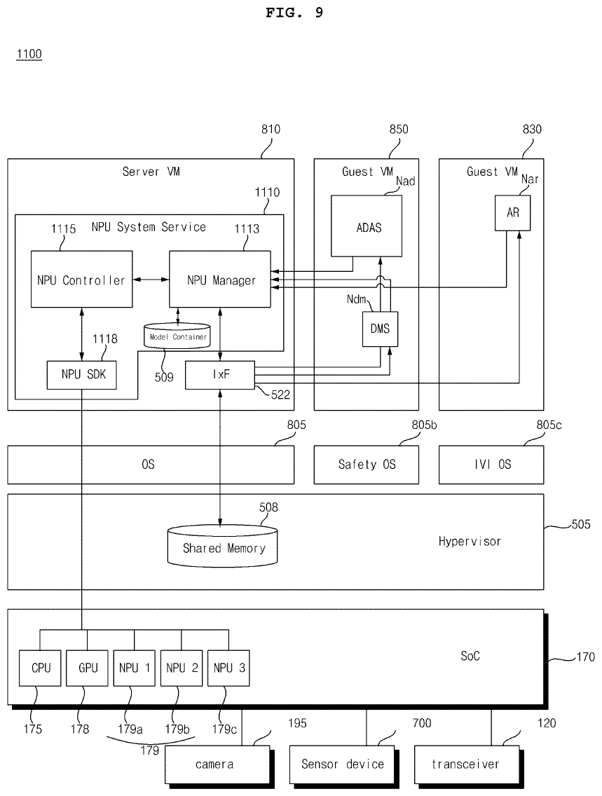

FIG. 9 is a diagram illustrating an example of a system driven in a signal processing device according to an embodiment of the present disclosure.

Referring to the figure, the signal processing device 170 in the signal processing system 1000 according to an embodiment of the present disclosure includes a central processor 175 and at least one neural processor 179a to 179c.

Meanwhile, the signal processing device 170 according to an embodiment of the present disclosure may further include a graphic processor 178.

Meanwhile, the central processor 175 according to an embodiment of the present disclosure executes the hypervisor 505.

Meanwhile, a system 1100 driven in the signal processing device 170 according to an embodiment of the present disclosure executes a plurality of virtual machines 810, 830, and 850 on the hypervisor 505.

Specifically, the central processor 175 in the signal processing device 170 according to an embodiment of the present disclosure executes the hypervisor 505, and executes the plurality of virtual machines 810, 830, and 850 on the hypervisor 505.

Meanwhile, the central processor 175 in the signal processing device 170 according to an embodiment of the present disclosure executes an application for vehicle driving.

Meanwhile, upon determining application operation failure, the central processor 175 controls a second application, corresponding to the application, to be executed in another central processor or another signal processing device, and changes a reference fallback guarantee time for the application operation failure based on an application safety level.

Accordingly, the application for vehicle driving may be stably executed. Particularly, the application for vehicle driving may be stably executed based on a safety level.

Meanwhile, the signal processing device 170 according to an embodiment of the present disclosure may further include a shared memory 508.

In the drawing, an example is illustrated in which the hypervisor 505 is executed in the central processor 175, and the shared memory 508 is executed in the hypervisor 505.

Meanwhile, the signal processing device 170 according to an embodiment of the present disclosure may receive data from the camera device 195, the sensor device 700, the communication device 120, or the lidar device 196, and may perform signal processing by using the central processor 175, the graphic processor 178, and at least one the plurality of neural processors 179a to 179c.

Meanwhile, the sensor device 700 may continuously output sensor data to the signal processing device 170 during operation of a vehicle.

In this case, the sensor data are data from various vehicle sensor devices 700, and may include at least one of vehicle direction data, vehicle position data (global positioning system (GPS) data), vehicle angle data, vehicle speed data, vehicle acceleration data, vehicle inclination data, vehicle forward/backward movement data, battery data, fuel data, tire data, vehicle lamp data, vehicle internal temperature data, or vehicle internal humidity data.

Meanwhile, the camera device 195 may continuously output the camera data to the signal processing device 170 during vehicle operation.

Meanwhile, the lidar 196 may continuously output the lidar data to the signal processing device 170 during vehicle operation.

Meanwhile, the neural processor 179 may detect an object based on the camera data and may operate at a variable frame rate based on the object or may output result data including the object.

Meanwhile, the neural processor 179 may receive the camera at a fixed frame rate, may detect an object based on the camera data, and may operate at a variable frame rate based on the object or may output result data including the object.

Meanwhile, a first virtual machine 810, which is a server virtual machine, among the plurality of virtual machines 810, 830, and 850 may control operation of the neural processor 179.

Meanwhile, each of a second virtual machine 850 and a third virtual machine 830, which are guest virtual machines, among the plurality of virtual machines 810, 830, and 850 may execute an application.

In the drawing, an example is illustrated in which the second virtual machine 850 executes an ADAS application Nad or an autonomous driving application or a driver monitoring system (DMS) application Ndm, and the third virtual machine 830 executes an augmented reality (AR) application Nar.

While the first virtual machine 810 sequentially receives a request for a first operation, a request for a second operation, and a request for a third operation from a plurality of applications executed in at least one of the plurality of virtual machines 810, 830, and 850, if parallel processing of the first operation and the third operation may be performed, the first virtual machine 810 controls the first neural processor 179a to perform parallel processing of the first operation and the third operation, and to process the second operation after completing the first operation and the third operation. Accordingly, the neural processor may operate efficiently. Further, power consumption may be reduced.

Meanwhile, while the first virtual machine 810 receives a request for a fourth operation after receiving the request for the third operation, if the operation layers during the second operation and the fourth operation may be shared, the first virtual machine 810 controls the first neural processor 179a to continuously process the second operation and the fourth operation after completing the first operation and the third operation. Accordingly, the neural processor may operate efficiently.

Meanwhile, upon receiving a request for a plurality of operations from a plurality of applications, the first virtual machine 810 may change the arrangement of data about the plurality of operations in an internal memory 1805 of the first neural processor 179a. Accordingly, the neural processor may operate efficiently.

Meanwhile, the first virtual machine 810 may execute a neural system service 1110 to control at least one neural processor 179a to 179c.

Meanwhile, the upon receiving a request for a plurality of operations from a plurality of applications, the neural system service 1110 may change the arrangement of data about the plurality of operations in the internal memory 1805 of the first neural processor 179a. Accordingly, the neural processor may operate efficiently.

Meanwhile, the neural system service 1110 may execute or include a neural manager 113 for managing at least one neural processor 179a to 179c, a neural controller 1115 for controlling or determining an inference method of at least one neural processor 179a to 179c, and a neural interface 1118 for interfacing with at least one neural processor 179a to 179c.

Meanwhile, the neural system service 1110 may further execute or include a model container 509 for managing a model parameter interface related to operation of the neural processor 179, and versions of learning files.

The neural manager 113 may perform artificial intelligence (AI) model management, learning model management, camera data management, sensor data management, or command queue management.

The neural controller 1115 may determine an optimal inference method of at least one neural processor 179a to 179c, or may perform queuing, partitioning, caching, or scalable coding, or may control at least one neural processor 179a to 179c.

The neural interface 1118 may execute an application program interface (API) associated with an accelerator of at least one neural processor 179a to 179c.

Meanwhile, the interface 522 in the first virtual machine 810 may perform interfacing between the neural system service 1110 and the model container 509 or between the neural system service 1110 and the shared memory 508.

Meanwhile, the interface 522 in the first virtual machine 810 may perform interfacing for the first virtual machine 810.

Meanwhile, the interface 522 in the first virtual machine 810 may perform interfacing for the ADAS application Nad or the driver monitoring system (DMS) application Ndm which are executed in the second virtual machine 850, or the augmented reality (AR) application Nar executed in the third virtual machine 830.

For example, the interface 522 in the first virtual machine 810 may control the camera data or the second data or the sound data to be transmitted to the neural processor 179 by using the shared memory 508.

Meanwhile, the interface 522 in the first virtual machine 810 may control result data, output from the neural processor 179 and written to the shared memory 508, to be transmitted to the neural system service 1110.

Meanwhile, the interface 522 in the first virtual machine 810 may control the result data, output from the neural processor 179 and written to the shared memory 508, to be transmitted to the ADAS application Nad or the driver monitoring system (DMS) application Ndm which are executed in the second virtual machine 850, or the augmented reality (AR) application Nar executed in the third virtual machine 830.

Meanwhile, the first virtual machine 810 may be executed on the first operating system 805, the second virtual machine 850 may be executed on the second operating system 805b having a high level of safety, and the third virtual machine 830 may be executed on the third operating system 805c.

That is, the plurality of virtual machines 810, 830, and 850 may be executed on different operating systems or at least two operating systems.

Meanwhile, the second operating system 805b may be an operating system corresponding to the second safety level such as ASIL D, and the third operating system 805c may be an operating system corresponding to the first safety level such as ASIL B.

Meanwhile, the first operating system 805 may be an operating system corresponding to the second safety level such as ASIL D, but is not limited thereto, and may be an operating system corresponding to the first safety level such as ASIL B.

Meanwhile, the neural manager 113 may manage requirements for executing an artificial neural network-based application, may control neural network weight data, and may process required input data.

Meanwhile, the neural manager 1113 may sequentially process optimized command queues using a hardware accelerator, and may transmit an operation result to the application.

The requirements for executing the application may include operation priority, dependency, and accuracy of a neural network. The operation priority refers to a relationship in which the first operation is required to be always processed preferentially compared to the second operation, or if the neural network is a safety-critical neural network, the neural network is required to processed first before other candidate neural networks in the command queue are processed, and the operation priority is a predetermined value.

Meanwhile, the neural network weight data may refer to a stored file in which element values of each matrix are architected in the process of inferring results of a neural network calculated by performing a series of matrix operations.

The neural network weight data may be pre-stored in the model container 509 of the neural system service 1110 via an API call of the neural system service 1110 during an application installation process.

Meanwhile, base weight data loaded in the model container 509 may be automatically converted to various levels of discretization and stored during a system initialization process. For example, if the base weight is defined as FP32, the base weight may be sub-discretized to levels INT8, INT16, and FP16, such that a total of four weight files may be stored.

The required input data may refer to input signals, such as vehicle speed, current location, radar, lidar, camera image, and intermediate to final operation result values of a preceding neural network, etc., which are required for operation of a current neural network.

The input data may be transmitted in real time from the server virtual machine to the shared memory 509 in the hypervisor 505 through an interface implemented by the central processor 175.

The command queue is a memory buffer with a sequential, First In First Out (FIFO) data structure and may define a series of sequences for processing operations of an artificial neural network via a hardware accelerator.

One neural network operation request entering the command queue may be transmitted along with metadata, such as application name, location of an application virtual machine, storage destination for operation results, etc., hardware accelerator control setpoints, memory location of input data, and memory location information for each discretization level of weight data.

The hardware accelerator control setpoints may include a unique number of a hardware accelerator responsible for operations, current target discretization level (INT8, INT16, FP16, FP32, etc.) of weight data, and a mapping table in which a target neural network weight position is mapped to each address in an internal memory of the hardware accelerator.

Meanwhile, the neural controller 1115 may perform scheduling of an optimized command queue based on requested artificial neural network operation instructions and availability of current hardware resources, and may control an actual hardware accelerator according to expected operation of the command queue.

The neural controller 1115 may optimize the command queue by receiving requirements for neural network operation from the neural manager 1113.

In other words, the command queue may be optimized by checking priority, dependency, and accuracy metadata for each slot in the current command queue, and performing simulated scheduling of a combination of command queues in a direction that maximizes the use of hardware within a unit time and minimizes latency for individual operation requests, when various queue optimization methods (Partitioning, Caching, Accuracy Coding, etc.) are applied to all candidate commands in the current command queue.

A request for a weight file (learning model) may be sent to the neural manager 113 based on the optimal slot position obtained in this manner, and the weight file may be loaded into a hardware internal memory.

By using partitioning among the optimization methods, if two neural networks are managed as one virtual neural network and input in response to a hardware operation request, start and end positions of the weight of a first operation corresponding to an address number of the hardware internal memory may be recorded in the mapping table, followed by recording start and end positions of the weight of a second operation in the mapping table.

In this manner, the hardware accelerator performs parallel processing of one virtual neural network, but the neural controller 1115 separates the operation result into results of the first operation and the second operation through the mapping table, so as to separately transmit the operation results to individual applications.

After completing the above initialization process, the neural controller 1115 may receive a request for sequentially processing command queues from the neural manager 1113.

In this case, the neural controller 1115 may retrieve input data, prepared in advance by the neural manager 1113, from an input data queue to form a pair of a neural network weight and corresponding input data, so as to control operation processing to be performed through hardware accelerator API.

Unlike the initial operation requirements, in the case in which a discretization level of the current neural network is changed in specific circumstances, the neural controller 1115 may perform bitwise concatenation of a weight conversion difference value Delta of the hardware internal memory to a base weight of the current internal memory, thereby converting in real time a discretization level of the base weight of the internal memory.

Meanwhile, the central processor 175 executes an application for vehicle driving, and upon determining processor 175 application operation failure, the central controls another central processor 175 or another signal processing device 170 to execute a second application corresponding to the application, and changes a reference fallback guarantee time for the application operation failure based on an application safety level.

Meanwhile, the above fallback guarantee time may refer to a period from a fallback start point to a fallback end point.

Alternatively, the fallback guarantee time may refer to a period from a time point at which application operation failure or application failure is determined, to a fallback end point via a fallback start point.

Meanwhile, the safety level may refer to an Automotive Safety Integrity Level (ASIL) or an autonomous driving level, or a combination of the ASIL and autonomous driving level.

Accordingly, the application for vehicle driving may be stably executed. Particularly, the application for vehicle driving may be stably executed based on the safety level.

Meanwhile, if a safety level of an application is a first safety level corresponding thereto, the central processor 175 may set a reference fallback guarantee time to a first time, and if a safety level of an application is a second safety level higher than the first safety level, the central processor 175 may set the reference fallback guarantee time to a second time longer than the first time. Accordingly, the application for vehicle driving may be stably executed.

For example, the central processor 175 may set the reference fallback guarantee time to a first time of about 10 seconds for a first application corresponding to ASIL D in the case in which an autonomous driving level is a third level, and the central processor 175 may set the reference fallback guarantee time to a second time of about 30 seconds for a second application corresponding to ASIL D in the case in which an autonomous driving level is a fourth level. Accordingly, the application for vehicle driving may be stably executed based on the safety level.

In another example, the central processor 175 may set the reference fallback guarantee time to about 7 seconds for a third application corresponding to ASIL B in the case in which an autonomous driving level is a third level, and the central processor 175 may set the reference fallback guarantee time to about 10 seconds for a fourth application corresponding to ASIL D in the case in which an autonomous driving level is a third level. Accordingly, the application for vehicle driving may be stably executed based on the safety level.

In yet another example, in the case in which a safety level of an augmented reality (AR) application Nar is a first safety level corresponding to ASIL B, the central processor 175 may set the reference fallback guarantee time to the first time of about 10 seconds, and in the case in which a safety level of an ADAS application Nad is a second safety level corresponding to ASIL D higher than ASIL B, the central processor 175 may set the reference fallback guarantee time to the second time of about 30 seconds. Accordingly, the application for vehicle driving may be stably executed based on the safety level.

Meanwhile, in the case in which a safety level of an application is a third safety level lower than the first safety level, the central processor 175 may set the reference fallback guarantee time to a third time shorter than the first time. Accordingly, the application for vehicle driving may be stably executed based on the safety level.

For example, the central processor 175 may set the reference fallback guarantee time to about 1 second for a fifth application corresponding to ASIL D or ASIL B, in the case in which an autonomous driving level is a second level.

In another example, the central processor 175 may set the reference fallback guarantee time to about 0.7 seconds for a sixth application corresponding to QM, in the case in which an autonomous driving level is a second level.

In yet another example, in the case in which a safety level of an augmented reality (AR) application Nar is a third safety level corresponding to QM lower than ASIL B, the central processor 175 may set the reference fallback guarantee time to a third time of about 0.5 seconds. Accordingly, the application for vehicle driving may be stably executed based on the safety level.

Meanwhile, in the case in which the second virtual machine 850 among the plurality of virtual machines 810, 830, and 850 executes an application with a safety level higher than that of the third virtual machine 830, the central processor 175 may control a reference fallback guarantee time of an application executed in the second virtual machine 850 to be greater than a reference fallback guarantee time of an application executed in the third virtual machine.

For example, in the case in which the second virtual machine 850 executes a first application with an autonomous driving level being a fourth level, the central processor 175 may set the reference fallback guarantee time to about 30 seconds, and in the case in which the third virtual machine 830 executes a second application with an autonomous driving level being a third level, the central processor 175 may set the reference fallback guarantee time to about 10 seconds. Accordingly, the application for vehicle driving may be stably executed based on the safety level.

In another example, in the case in which the second virtual machine 850 executes an ADAS application Nad corresponding to ASIL D, the central processor 175 may set the reference fallback guarantee time of the ADAS application Nad to about 30 seconds, and in the case in which the third virtual machine 830 executes an augmented reality (AR) application Nar corresponding to ASIL B, the central processor 175 may set the reference fallback guarantee time of the AR application Nar to about 10 seconds. Accordingly, the application for vehicle driving may be stably executed based on the safety level.

FIG. 10A is a flowchart illustrating a method of operating a signal processing device according to an embodiment of the present disclosure.

Referring to the figure, the processor 175 in the signal processing device 170 according to an embodiment of the present disclosure calculates a time to forward collision or a time to avoid forward collision with an object OBm in front of a vehicle (S1010).

For example, the processor 175 in the signal processing device 170 may receive a front image from a front camera 195a, and may calculate the time to forward collision or the time to avoid forward collision with the object OBm in front of a vehicle based on the front image.

In another example, the processor 175 in the signal processing device 170 may receive a sensing signal from a lidar 196 or a radar 197, and may calculate the time to forward collision or the time to avoid forward collision with the object OBm in front of a vehicle based on the sensing signal.

Then, the processor 175 in the signal processing device 170 may calculate a forward attention level of a driver OWa based on a vehicle internal image received from an internal camera 195i (S1020).

For example, the processor 175 in the signal processing device 170 may detect a face of the driver in the vehicle internal image from the internal camera 195i, and may detect a face direction or attention direction of the driver.

Further, the processor 175 may y calculate a forward attention level of the driver OWa based on the face direction or attention direction of the driver.

Then, the processor 175 in the signal processing device 170 may vary a control time point of forward collision avoidance based on the forward attention level (S1030).

Specifically, the processor 175 in the signal processing device 170 varies the control time point of forward collision avoidance based on the forward attention level and the time to forward collision or the time to avoid forward collision. Accordingly, adaptive vehicle control may be performed according to the forward attention level of the driver OWa.

FIG. 10B is a flowchart illustrating a method of operating a signal processing device according to another embodiment of the present disclosure.

Referring to FIG. 10B, the processor 175 in the signal processing device 170 according to another embodiment of the present disclosure calculates a time to forward collision or a time to avoid forward collision with an object OBm in front of a vehicle (S1010).

For example, the processor 175 in the signal processing device 170 may receive a front image from a front camera 195a, and may calculate the time to forward collision or the time to avoid forward collision with the object OBm in front of the vehicle based on the front image.

Then, the processor 175 in the signal processing device 170 may calculate a forward attention level of a driver OWa based on a vehicle internal image received from an internal camera 195i (S1020).

For example, the processor 175 in the signal processing device 170 may calculate a forward attention level of the driver OWa based on a face direction or attention direction of the driver in the vehicle internal image from the internal camera 195i.

Then, the processor 175 in the signal processing device 170 may determine whether the forward attention level is a first level (S1022), and if so, the processor 175 may set a control time point of forward collision avoidance to a first time point Tmb (S1024).

Meanwhile, in the case in which the forward attention level is not the first level in operation 1022 (S1022), the processor 175 in the signal processing device 170 may determine whether the forward attention level is a second level lower than the first level (S1026), and if so, the processor 175 may set a control time point of forward collision avoidance to a second time point Tma before the first time point Tmb (S1028). Accordingly, adaptive vehicle control may be performed according to the forward attention level of the driver OWa.

Meanwhile, in the case in which the forward attention level is a third level between the first level and the second level, the processor 175 may set a control time point of forward collision avoidance to a third time point between the first time point Tmb and the second time point Tma. Accordingly, adaptive vehicle control may be performed according to the forward attention level of the driver OWa.

Meanwhile, the processor 175 may set the control time point of forward collision avoidance to a later time point as the forward attention level increases. Accordingly, adaptive vehicle control may be performed according to the forward attention level of the driver OWa.

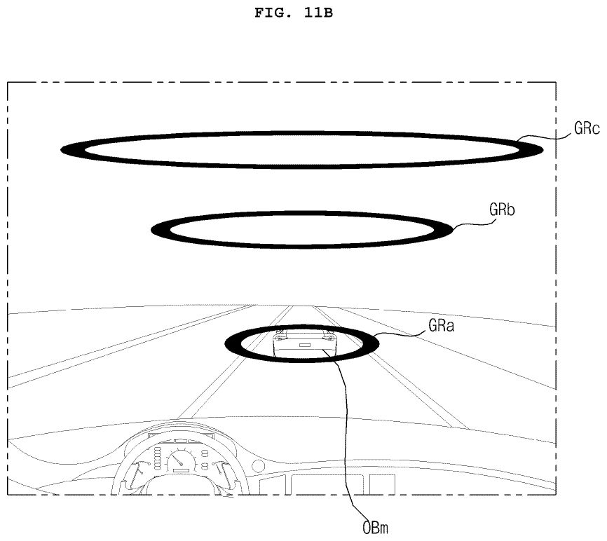

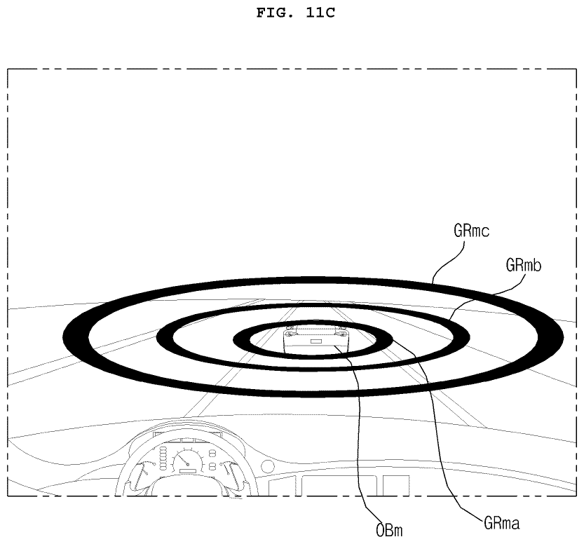

FIGS. 11A to 15 are diagrams referred to in the description of operation of FIGS. 9 to 10B.

FIG. 11A is a diagram illustrating an example of the interior of a vehicle.

Referring to the figure, a driver OWa, a windshield Arma at the front of the driver OWa, a roof Armf at the top of the windshield Arma, driver's seat glass Armb on one side of the A-pillar, passenger's seat glass Armd on one side of the A-pillar, dashboard Armc, and the like may be located in a vehicle.

In the case in which a face direction or attention direction of the driver OWa is toward the windshield Arma, the processor 175 may set the forward attention level to a highest level.

That is, in the case in which a face direction or attention direction of the driver OWa is toward the windshield Arma, the processor 715 may set a forward attention level to a higher level, compared to the case where a face direction or attention direction of the driver OWa is toward the roof Armf, the driver's seat glass Armb or the passenger's seat glass Armd, or the dashboard Armc.

FIG. 11B is a diagram illustrating an example of the front of a vehicle.

Referring to the figure, the attention of the driver OWa may be fixated on any one of a plurality of regions GRa, GRb, and GRc in front of the windshield Arma of the vehicle.

The processor 175 in the signal processing device 170 may set a highest forward attention level for a first region GRa, in which a preceding vehicle OBm is located, among the plurality of regions GRa, GRb, and GRc.

For example, the processor 175 in the signal processing device 170 may set a highest forward attention level for the first region GRa in which the preceding vehicle OBm is located, and may set a lowest forward attention level for a third region GRc and set an intermediate level for a second region GRb.

That is, the processor 175 in the signal processing device 170 may set the highest forward attention level for the first region GRa in which the preceding vehicle OBm is located, and may control the forward attention level to decrease away from the preceding vehicle OBm.

FIG. 11C is a diagram illustrating another example of the front of a vehicle.

Referring to the figure, the attention of the driver OWa may be fixated on any one of a plurality of regions GRma, GRmb, and GRmc in front of the windshield Arma of the vehicle.

Meanwhile, the processor 175 in the signal processing device 170 may vary the forward attention level according to a region size of the plurality of regions GRma, GRmb, and GRmc including the preceding vehicle OBm.

For example, the processor 175 in the signal processing device 170 may set a highest forward attention level for a region GRma having a smallest size among the plurality of regions GRma, GRmb, and GRmc including the preceding vehicle OBm.

In another example, the processor 175 in the signal processing device 170 may set a lowest forward attention level for a region GRmc having a largest size among the plurality of regions GRma, GRmb, and GRmc including the preceding vehicle OBm.

Meanwhile, the processor 175 in the signal processing device 170 may set a forward attention level of a region GRmn having a medium size so that the forward attention level of the region GRmn is lower than the forward attention level of the region GRma and higher than the forward attention level of the region GRmc, among the plurality of regions GRma, GRmb, and GRmc including the preceding vehicle OBm.

That is, the processor 175 in the signal processing device 170 may set the highest forward attention level for the region GRma having the smallest size among the plurality of regions GRma, GRmb, and GRmc including the preceding vehicle OBm, and may control the forward attention level to decrease as the region size increases.

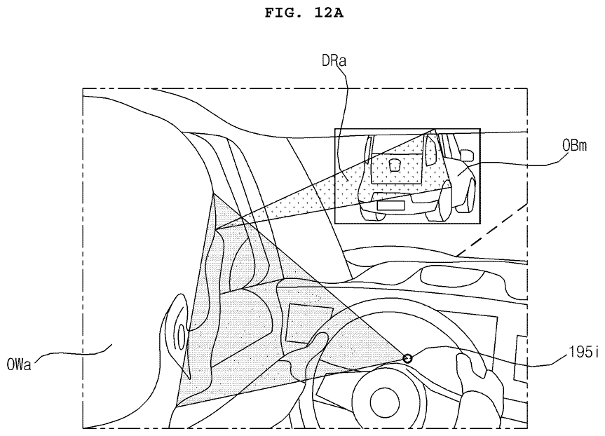

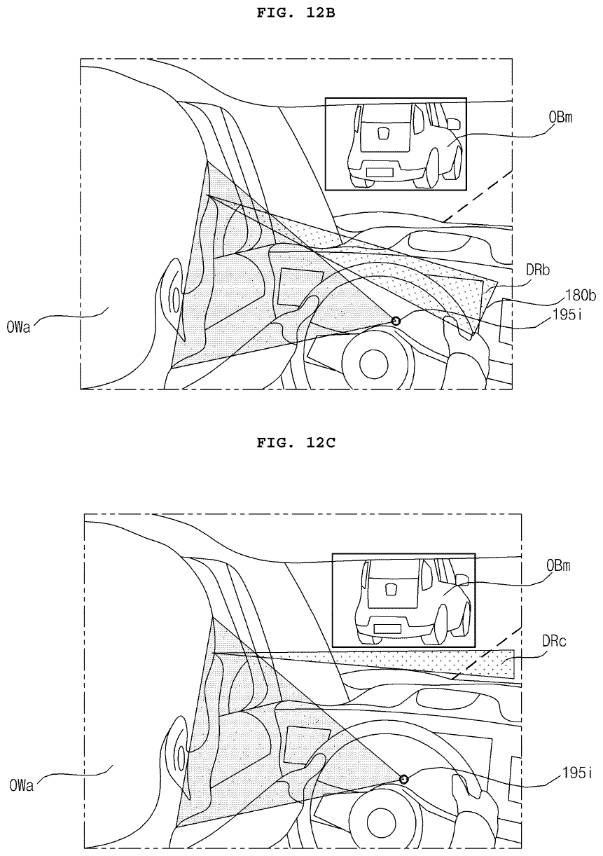

FIGS. 12A to 12C are diagrams illustrating an example of identifying a driver's attention using an internal camera.

FIG. 12A is a diagram illustrating an example in which a driver's attention is directed at the preceding vehicle OBm.

Referring to the figure, the processor 175 in the signal processing device 170 may detect a face direction or attention direction of the driver OWa based on a vehicle internal image from the internal camera 195i.

Meanwhile, as illustrated in FIG. 12A, the processor 175 in the signal processing device 170 may set a forward attention level to a first level in the case in which a attention direction DRa of the driver OWa is oriented toward the preceding vehicle OBm.

FIG. 12B is a diagram illustrating an example in which a driver's attention is directed at the second display 180b in the vicinity of a vehicle internal dashboard.

Referring to the figure, the processor 175 in the signal processing device 170 may set the forward attention level to a second level lower than the first level, in the case in which the attention direction DRb of the driver OWa is oriented toward the second display 180b or a mobile terminal (not shown) in the vicinity of the dashboard.

FIG. 12C is a diagram illustrating an example in which a driver's attention is directed at a position between the preceding vehicle OBm and the interior of a vehicle.

Referring to the figure, the processor 175 in the signal processing device 170 may set the forward attention level to a third level between the first level and the second level, in the case in which the attention direction DRc of the driver OWa is oriented toward the position between the preceding vehicle OBm and the interior of a vehicle.

Referring to FIGS. 12A to 12C, the processor 175 in the signal processing device 170 may calculate a distraction factor based on the attention direction of the driver OWa.

In this case, the distraction factor may be inversely proportional to the forward attention level.

For example, the processor 175 in the signal processing device 170 may set a lowest distraction factor level in the case in which the attention direction DRa of the driver OWa is oriented toward the preceding vehicle OBm as illustrated in FIG. 12A, and may set a highest distraction factor level in the case in which the attention direction DRa of the driver OWa is oriented toward the second display 180b or a mobile terminal (not shown) in the vicinity of the dashboard.

Meanwhile, the processor 175 in the signal processing device 170 may calculate the time to forward collision or the time to avoid forward collision with an object in front of the vehicle based on the distraction factor level, and may vary the control time point of forward collision avoidance based on the forward attention level and the time to forward collision or the time to avoid forward collision.

For example, the processor 175 in the signal processing device 170 may set the control time point of forward collision avoidance to an earlier time point as the distraction factor level increases. Accordingly, adaptive vehicle control may be performed according to a distraction factor level of a driver.

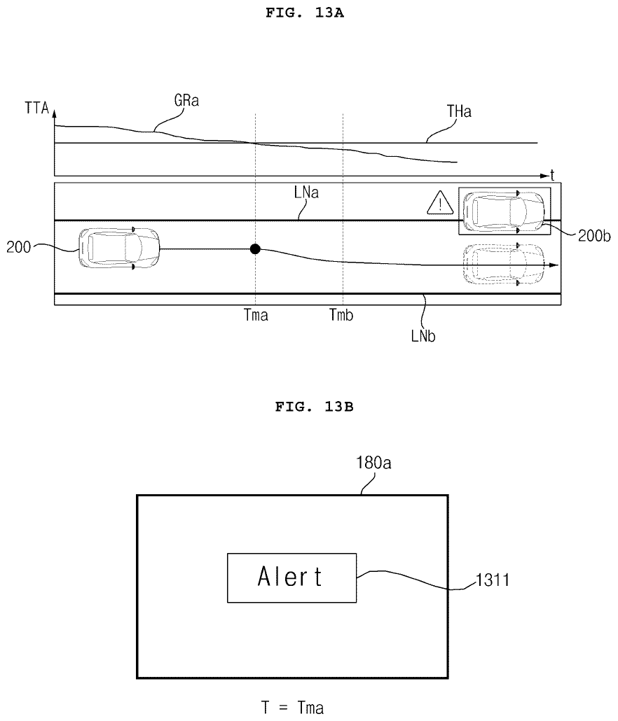

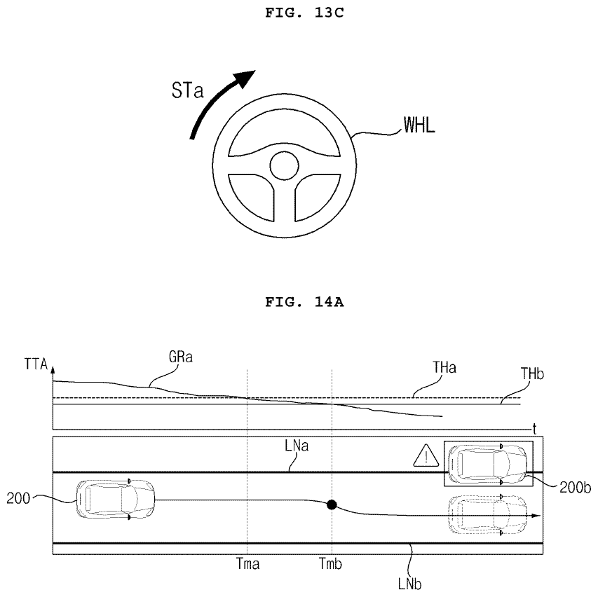

FIGS. 13A to 13C are diagrams illustrating an example of vehicle control in the case in which a driver fails to keep eyes forward or look straight ahead.

FIG. 13A illustrates a vehicle 200 and a preceding vehicle 200b.

Referring to the figure, the vehicle 200 is driven in a lane between two lines LNa and LNb, and the preceding vehicle 200b is driven on a partial line LNa.

Meanwhile, the processor 175 in the signal processing device 170 may set a forward attention level to the second level or the third level lower than the first level, in the case in which the attention direction of the driver OWa is not oriented toward the preceding vehicle 200b.

Meanwhile, the processor 175 in the signal processing device 170 may perform a control operation for forward collision avoidance based on a distance from the preceding vehicle 200b and the like.

To this end, the processor 175 in the signal processing device 170 may calculate a time-to-collision (TTC) or a time-to-avoid (TTA) for forward collision avoidance.

In the figure, a graph GRa of a predicted time to avoid collision with the preceding vehicle is shown.

Meanwhile, the processor 175 in the signal processing device 170 may control an allowable time in the predicted TTA to increase as the forward attention level decreases.

That is, in the case in which the forward attention level is the second level or the third level, the processor 175 in the signal processing device 170 may set an allowable time in the predicted TTA to a first time THa.

Meanwhile, in the case in which the predicted TTA is less than or equal to the first time THa which is the allowable time, the processor 175 in the signal processing device 170 may output an alert message for forward collision avoidance.

FIG. 13B is a diagram illustrating an example of outputting an alert message 1311 to the first display 180a at a time point Tma.

Referring to the figure, the processor 175 in the signal processing device 170 may control the alert message 1311 to be output to the first display 180a at the time point Tma in the case in which the predicted TTA is less than the first time THa which is the allowable time.

Accordingly, the alert message 1311 may be output at the time point Tma which is earlier than a time point Tmb.

As a result, an action for forward collision avoidance may be induced as the driver OWa recognizes the alert message 1311. FIG. 13C is a diagram illustrating an example of setting a level of change of a steering angle to a second predetermined level at the time point Tma.

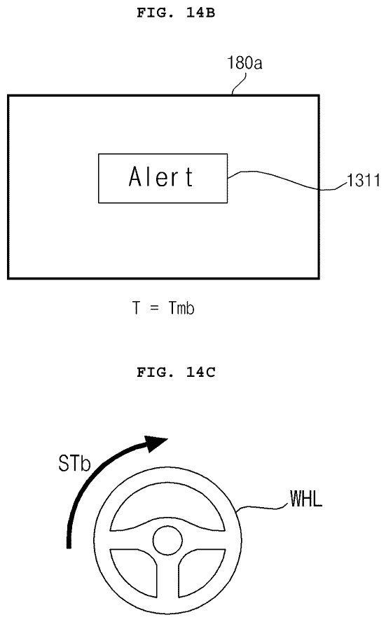

Referring to the figure, the processor 175 in the signal processing device 170 may set a level of change of a steering angle for forward collision avoidance to a second predetermined level STa lower than a first predetermined level STb (see FIG. 14C), at the time point Tma in the case in which the predicted TTA is less than the first time THa which is the allowable time.

That is, the steering angle of the vehicle 200 may be changed based on the second predetermined level at the time point Tma earlier than the time point Tmb.

To this end, the processor 175 in the signal processing device 170 may output a steering angle change signal, corresponding to the second predetermined level STa, at the time point Tma.

Meanwhile, the steering driver 652 receives the steering angle change signal via the signal processing device 170, the communication module EM, the ECU 770, etc., and may change the steering angle based on the second predetermined level STa of the steering angle change signal.

As a result, the forward collision avoidance control may be performed after the time point Tma. That is, the vehicle 200 may move to the right side of the preceding vehicle 200b.

FIGS. 14A to 14C are diagrams illustrating an example of vehicle control in the case in which a driver keeps eyes forward or looks straight ahead.

First, FIG. 14A illustrates the vehicle 200 and the preceding vehicle 200b.

Referring to the figure, the vehicle 200 is driven in a lane between two lines LNa and LNb, and the preceding vehicle 200b is driven on a partial line LNa.

Meanwhile, the processor 175 in the signal processing device 170 may set a forward attention level to the first level in the case in which the attention direction of the driver OWa is fixed to the preceding vehicle 200b.

Meanwhile, the processor 175 in the signal processing device 170 may perform a control operation for forward collision avoidance based on a distance from the preceding vehicle 200b and the like.

In the figure, a graph GRa of a predicted time to avoid collision with the preceding vehicle is shown.

Meanwhile, the processor 175 in the signal processing device 170 may control an allowable time in the predicted TTA to decrease as the forward attention level increases.

That is, in the case in which the forward attention level is the first level, the processor 175 in the signal processing device 170 may set an allowable time in the predicted TTA to a second time THb less than the first time THa.

Meanwhile, in the case in which the predicted TTA is less than or equal to the second time THb which is the allowable time, the processor 175 in the signal processing device 170 may output an alert message for forward collision avoidance.

FIG. 14B is a diagram illustrating an example of outputting an alert message 1311 to the first display 180a at a time point Tmb.

Referring to the figure, the processor 175 in the signal processing device 170 may control the alert message 1311 to be output to the first display 180a at the time point Tmb in the case in which the predicted TTA is less than or equal to the second time THb which is the allowable time.

Accordingly, the alert message 1311 may be output at the time point Tmb which is later than the time point Tma.

As a result, an action for forward collision avoidance may be induced as the driver OWa recognizes the alert message 1311.

FIG. 14C is a diagram illustrating an example of setting a level of change of a steering angle to a first predetermined level.

Referring to the figure, the processor 175 in the signal processing device 170 may set a level of change of a steering angle for forward collision avoidance to a first predetermined level at the time point Tmb in the case in which the predicted TTA is less than or equal to the second time THb which is the allowable time.

That is, the steering angle of the vehicle 200 may be changed based on the first predetermined level at the time point Tmb later than the time point Tma.

Meanwhile, the processor 175 in the signal processing device 170 may output a steering angle change signal, corresponding to the first predetermined level STb, at the time point Tmb.

Meanwhile, the steering driver 652 receives the steering angle change signal via the signal processing device 170, the communication module EM, the ECU 770, etc., and may change the steering angle based on the first predetermined level STb of the steering angle change signal. As a result, the forward collision avoidance control may be performed after the time point Tmb.

Meanwhile, as the steering angle change control starts at the time point Tmb later than the time point Tma, the processor 175 in the signal processing device 170 may control the first predetermine level STb to be higher than the second predetermined level STa.

Accordingly, the steering angle or steering torque in FIG. 14C may be greater than the steering angle or steering torque in FIG. 13C.

Considering FIGS. 13A through 14C together, the processor 175 may change an output time point of the alert message 1311 for forward collision avoidance in response to the forward attention level. Accordingly, adaptive vehicle control may be performed according to the forward attention level of the driver OWa.

Meanwhile, in the case in which the forward attention level is the first level, the processor 175 may set an output time point of the alert message 1311 for forward collision avoidance to a first output time point Tmb, and in the case in which the forward attention level is the second level lower than the first level, the processor 175 may set an output time point of the alert message 1311 for forward collision avoidance to a second output time point Tma before the first output time point Tmb. Accordingly, the alert message 1311 may be output adaptively according to the forward attention level of the driver OWa.

Meanwhile, the processor 175 may control the alert message 1311 for forward collision avoidance to be output at a later time point as the forward attention level increases. Accordingly, the alert message 1311 may be output adaptively according to the forward attention level of the driver OWa.

Meanwhile, the processor 175 may vary the level of change of the steering angle for forward collision avoidance in response to the forward attention level. Accordingly, adaptive vehicle control may be performed according to the forward attention level of the driver OWa.

Meanwhile, in the case in which the forward attention level is the first level, the processor 175 may set the level of change of the steering angle for forward collision avoidance to the first predetermined level STb, and in the case in which the forward attention level is the second predetermined level STa lower than the first predetermined level, the processor 175 may set the level of change of the steering angle for forward collision avoidance to the second predetermined level STa lower than the first predetermined level STb. Accordingly, adaptive vehicle control may be performed according to the forward attention level of the driver OWa.

Meanwhile, the processor 175 may control the level of change of the steering angle forward collision avoidance to increase as the forward attention level increases. Accordingly, adaptive vehicle control may be performed according to the forward attention level of the driver OWa.

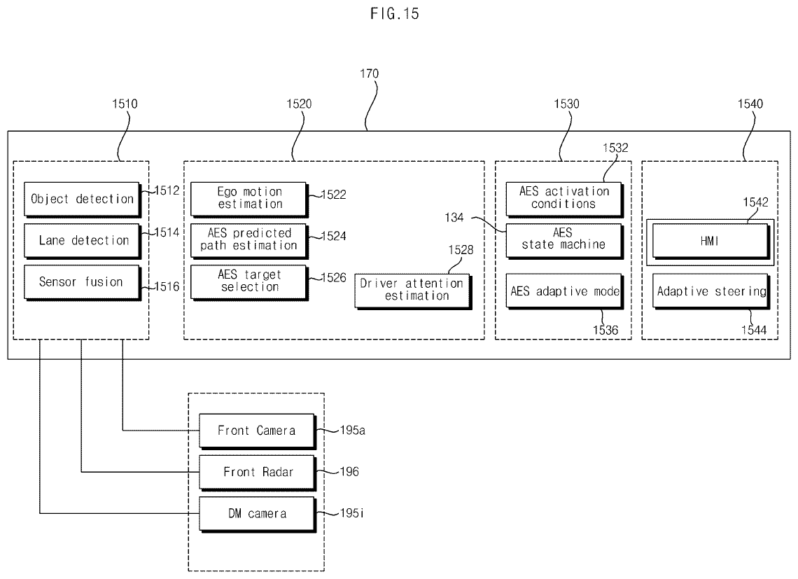

FIG. 15 is an exemplary internal block diagram of a signal processing device according to an embodiment of the present disclosure.

Referring to the figure, the signal processing device 170 according to an embodiment of the present disclosure may receive a front image, a vehicle internal image, or a sensing signal from the front camera 195a, the internal camera 195i, or the lidar 196, respectively.

Meanwhile, the signal processing device 170 may include a detector 1510 configured to detect an object or lane or the like based on the received image or sensing signal, a motion estimator 1520 configured to estimate a motion based on the detected object or lane, etc., a determiner 1530 configured to determine vehicle control based on the estimated motion, and an application executor 1540 configured to execute an application.

Meanwhile, the detector 1510 may include an object detector 1512 configured to detect an object in front of a vehicle from the front image or to detect a driver's face or eyes from the vehicle internal image, a lane detector 1514 configured to detect a lane in front of the vehicle from the front image, and a sensor fusion part 1516 configured to synthesize an image signal or a sensing signal.

Meanwhile, the motion estimator 1520 may include an ego-motion estimator 1522 configured to estimate an ego-motion related to estimating a driving direction of the vehicle 200, a predicted path estimator 1524 configured to estimate a predicted path of the vehicle 200, and a target selector 1526 configured to select an Autonomous Emergency Steering (AES) target, and a attention level estimator 1528 configured to calculate a forward attention level of a driver.

Meanwhile, the determiner 1530 may include a condition determiner 1532 configured to determine an AES activation condition based on signals from the ego-motion estimator 1522, the predicted path estimator 1524, the target selector 1526, or the attention level estimator 1528, a state machine determiner 1534 configured to determine an AES state machine, and an AES mode determiner 1536 configured to determine an AES mode.

Meanwhile, the application executor 1540 may include an alert application 1542 configured to provide a warning for forward collision avoidance or an AES control application 1544 configured to execute the AES mode, based on signals from the condition determiner 1532, the state machine determiner 1534, or the AES mode determiner 1536.

Meanwhile, as illustrated in FIG. 9, the processor 175 in the signal processing device 170 may execute the driver monitoring application Ndm based on the vehicle internal image, and may execute the AES control application 1544 based on the front image.

In this case, the driver monitoring application Ndm may include a plurality of microservices.

For example, the driver monitoring application Ndm may include the object detector 1512, the attention level estimator 1528, and the like which are microservices.

Meanwhile, the processor 175 in the signal processing device 170 may execute the object detector 1512, the attention level estimator 1528, and the like corresponding to ASIL D which is the second safety level.

To this end, the processor 175 in the signal processing device 170 may control the virtual machine 850, corresponding to the second safety level such as ASIL D, to execute the object detector 1512, the attention level estimator 1528, and the like. Accordingly, the driver monitoring application Ndm may be stably executed.

Meanwhile, the processor 175 in the signal processing device 170 may execute the AES control application 1544.

In this case, the AES control application 1544 may include a plurality of microservices.

For example, the AES control application 1544 may include, as microservices, the object detector 1512, the lane detector 1514, the ego-motion estimator 1522, the predicted path estimator 1524, the target selector 1526, the attention level estimator 1528, the condition determiner 1532, the state machine determiner 1534, the AES mode determiner 1536, or the like.

To this end, the processor 175 in the signal processing device 170 may control the virtual machine 850, corresponding to the second safety level such as ASIL D, to execute the object detector 1512, the lane detector 1514, the ego-motion estimator 1522, the predicted path estimator 1524, the target selector 1526, the attention level estimator 1528, the condition determiner 1532, the state machine determiner 1534, the AES mode determiner 1536, or the like. Accordingly, the AES control application 1544 may be stably executed.

Then, the processor 175 in the signal processing device 170 may execute the alert application 1542 for forward collision avoidance, based on the vehicle internal image and the front image.

In this case, the alert application 1542 for forward collision avoidance may correspond to the first safety level such as QM or ASIL B.

To this end, the processor 175 in the signal processing device 170 may control the virtual machine 830, corresponding to the first safety level such as ASIL B, to execute the alert application 1542.

Meanwhile, the safety level of the alert application 1542 may be lower than the safety level of the driver monitoring application Ndm or the AES control application 1544.

Meanwhile, as illustrated in FIG. 9, the processor 175 may execute the plurality of virtual machines 810, 830, and 850 on the hypervisor 505, and some virtual machine 850 among the plurality of virtual machines 810, 830, and 850 may execute the driver monitoring application Ndm based on the vehicle internal image and may execute the AES control application 1544 based on the front image. Accordingly, adaptive vehicle control may be performed according to the forward attention level of the driver OWa.

Meanwhile, another virtual machine 830 among the plurality of virtual machines 810, 830, and 850 executes the alert application 1542 for forward collision avoidance, and the safety level of the alert application 1542 may be lower than the safety level of the driver monitoring application Ndm or the AES control application 1544.

Meanwhile, some virtual machine 850 among the plurality of virtual machines 810, 830, and 850 executes the plurality of microservices for the AES control application 1544 based on the front image, and may execute the plurality of microservices for the driver monitoring application Ndm based on the vehicle internal image. Accordingly, the AES control application 1544 and the driver monitoring application Ndm may be stably and efficiently executed. Further, vehicle control may be efficiently performed using the microservices.

As described above, a signal processing device and a vehicle control device including the same according to an embodiment of the present disclosure comprise a processor configured to receive a vehicle internal image from an internal camera, wherein the processor is configured to calculate a forward attention level of a driver based on the vehicle internal image, calculate a time to forward collision or a time to avoid forward collision with an object in front of a vehicle, and change a control time point of forward collision avoidance based on the forward attention level and the time to forward collision or the time to avoid forward collision. Accordingly, adaptive vehicle control may be performed according to the forward attention level of the driver.

Meanwhile, the processor may be configured to receive a front image from a front camera, and calculate the time to forward collision or the time to avoid forward collision with the object in front of the vehicle based on the front image. Accordingly, adaptive vehicle control may be performed according to the forward attention level of the driver.

Meanwhile, the processor may be configured to: in response to the forward attention level being a first level, set the control time point of forward collision avoidance to a first time point; and in response to the forward attention level being a second level lower than the first level, set the control time point of forward collision avoidance to a second time point before the first time point. Accordingly, adaptive vehicle control may be performed according to the forward attention level of the driver.

Meanwhile, in response to the forward attention level being a third level between the first level and the second level, the processor may be configured to set the control time point of forward collision avoidance to a third time point between the first time point and the second time point. Accordingly, adaptive vehicle control may be performed according to the forward attention level of the driver.

Meanwhile, the processor may be configured to set the control time point of forward collision avoidance to a later time point as the forward attention level increases. Accordingly, adaptive vehicle control may be performed according to the forward attention level of the driver.

Meanwhile, the processor may be configured to change an output time point of an alert message for forward collision avoidance based on the forward attention level. Accordingly, adaptive vehicle control may be performed according to the forward attention level of the driver.

Meanwhile, the processor may be configured to: in response to the forward attention level being a first level, set the output time point of the alert message for forward collision avoidance to a first output time point; and in response to the forward attention level being a second level lower than the first level, set the output time point of the alert message for forward collision avoidance to a second output time point before the first output time point. Accordingly, the alert message may be output adaptively according to the forward attention level of the driver.

Meanwhile, the processor may be configured to control the alert message for forward collision avoidance to be output at a later time point as the forward attention level increases. Accordingly, the alert message may be output adaptively according to the forward attention level of the driver.

Meanwhile, the processor may be configured to change a level of change of a steering angle for forward collision avoidance based on the forward attention level. Accordingly, adaptive vehicle control may be performed according to the forward attention level of the driver.

Meanwhile, the processor may be configured to: in response to the forward attention level being a first level, set the level of change of the steering angle for forward collision avoidance to a first predetermined level; and in response to the forward attention level being a second level lower than the first level, set the level of change of the steering angle for forward collision avoidance to a second predetermined level lower than the first predetermined level. Accordingly, adaptive vehicle control may be performed according to the forward attention level of the driver.

Meanwhile, the processor may be configured to increase the level of change of the steering angle for forward collision avoidance as the forward attention level increases. Accordingly, adaptive vehicle control may be performed according to the forward attention level of the driver.

Meanwhile, the processor may be configured to execute a driver monitoring application based on the vehicle internal image, and execute an Autonomous Emergency Steering (AES) control application based on the front image. Accordingly, adaptive vehicle control may be performed according to the forward attention level of the driver.

Meanwhile, the processor may be configured to execute an alert application for forward collision avoidance based on the vehicle internal image and the front image, wherein a safety level of the alert application may be lower than a safety level of the driver monitoring application or a safety level of the AES control application. Accordingly, the alert message may be output adaptively according to the forward attention level of the driver.

Meanwhile, the processor may be configured to execute a plurality of virtual machines on a hypervisor, wherein some virtual machine among the plurality of virtual machines may be configured to execute the driver monitoring application based on the vehicle internal image, and execute the AES control application based on the front image. Accordingly, adaptive vehicle control may be performed according to the forward attention level of the driver.

Meanwhile, another virtual machine among the plurality of virtual machines may be configured to execute the alert application for forward collision avoidance, wherein a safety level of the alert application may be lower than a safety level of the driver monitoring application or a safety level of the AES control application. Accordingly, the alert message may be output adaptively according to the forward attention level of the driver.

Meanwhile, some virtual machine among the plurality of virtual machines may be configured to execute a plurality of microservices for the AES control application based on the front image, and execute a plurality of microservices for the driver monitoring application based on the vehicle internal image. Accordingly, the AES control application and the driver monitoring application may be stably and efficiently executed. Further, vehicle control may be efficiently performed using the microservices.

A signal processing device and a vehicle control device including the same according to another embodiment of the present disclosure include a processor configured to receive a vehicle internal image from an internal camera and a front image from a front camera, wherein the processor is configured to calculate a forward attention level of a driver based on the vehicle internal image, calculate a time to forward collision or a time to avoid forward collision with an object in front of a vehicle based on the front image, and change a control time point of forward collision avoidance or a level of change of a steering angle for forward collision avoidance based on the forward attention level and the time to forward collision or the time to avoid forward collision. Accordingly, adaptive vehicle control may be performed according to the forward attention level of the driver.

It will be apparent that, although the preferred embodiments have been shown and described above, the present disclosure is not limited to the above described specific embodiments, and various modifications and variations can be made by those skilled in the art without departing from the gist of the appended claims. Thus, it is intended that the modifications and variations should not be understood independently of the technical spirit or prospect of the present disclosure.

What is claimed is:

1. A signal processing device comprising a processor configured to receive a vehicle internal image from an internal camera,
wherein the processor is configured to calculate a forward attention level of a driver based on the vehicle internal image, calculate a time to forward collision or a time to avoid forward collision with an object in front of a vehicle, and change a control time point of forward collision avoidance based on the forward attention level and the time to forward collision or the time to avoid forward collision.

2. The signal processing device of claim 1, wherein the processor is configured to receive a front image from a front camera, and calculate the time to forward collision or the time to avoid forward collision with the object in front of the vehicle based on the front image.

3. The signal processing device of claim 1, wherein the processor is configured to:
in response to the forward attention level being a first level, set the control time point of forward collision avoidance to a first time point; and
in response to the forward attention level being a second level lower than the first level, set the control time point of forward collision avoidance to a second time point before the first time point.

4. The signal processing device of claim 3, wherein in response to the forward attention level being a third level between the first level and the second level, the processor is configured to set the control time point of forward collision avoidance to a third time point between the first time point and the second time point.

5. The signal processing device of claim 1, wherein the processor is configured to set the control time point of forward collision avoidance to a later time point as the forward attention level increases.

6. The signal processing device of claim 1, wherein the processor is configured to change an output time point of an alert message for forward collision avoidance based on the forward attention level.

7. The signal processing device of claim 6, wherein the processor is configured to:
in response to the forward attention level being a first level, set the output time point of the alert message for forward collision avoidance to a first output time point; and
in response to the forward attention level being a second level lower than the first level, set the output time point of the alert message for forward collision avoidance to a second output time point before the first output time point.

8. The signal processing device of claim 6, wherein the processor is configured to control the alert message for forward collision avoidance to be output at a later time point as the forward attention level increases.

9. The signal processing device of claim 1, wherein the processor is configured to change a level of change of a steering angle for forward collision avoidance based on the forward attention level.

10. The signal processing device of claim 9, wherein the processor is configured to:
in response to the forward attention level being a first level, set the level of change of the steering angle for forward collision avoidance to a first predetermined level; and
in response to the forward attention level being a second level lower than the first level, set the level of change of the steering angle for forward collision avoidance to a second predetermined level lower than the first predetermined level.

11. The signal processing device of claim 9, wherein the processor is configured to increase the level of change of the steering angle for forward collision avoidance as the forward attention level increases.

12. The signal processing device of claim 2, wherein the processor is configured to execute a driver monitoring application based on the vehicle internal image, and execute an Autonomous Emergency Steering (AES) control application based on the front image.

13. The signal processing device of claim 12, wherein the processor is configured to execute an alert application for forward collision avoidance based on the vehicle internal image and the front image,
wherein a safety level of the alert application is lower than a safety level of the driver monitoring application or a safety level of the AES control application.

14. The signal processing device of claim 2, wherein the processor is configured to execute a plurality of virtual machines on a hypervisor,
wherein some virtual machine among the plurality of virtual machines is configured to execute the driver monitoring application based on the vehicle internal image, and execute the AES control application based on the front image.

15. The signal processing device of claim 14, wherein another virtual machine among the plurality of virtual machines is configured to execute the alert application for forward collision avoidance,
wherein a safety level of the alert application is lower than a safety level of the driver monitoring application or a safety level of the AES control application.

16. The signal processing device of claim 14, wherein some virtual machine among the plurality of virtual machines is configured to execute a plurality of microservices for the AES control application based on the front image, and execute a plurality of microservices for the driver monitoring application based on the vehicle internal image.

17. A signal processing device comprising a processor configured to receive a vehicle internal image from an internal camera and a front image from a front camera,
wherein the processor is configured to calculate a forward attention level of a driver based on the vehicle internal image, calculate a time to forward collision or a time to avoid forward collision with an object in front of a vehicle based on the front image, and change a control time point of forward collision avoidance or a level of change of a steering angle for forward collision avoidance based on the forward attention level and the time to forward collision or the time to avoid forward collision.

18. A vehicle control device comprising a signal processing device,
wherein the signal processing device comprises a processor configured to receive a vehicle internal image from an internal camera,
wherein the processor is configured to calculate a forward attention level of a driver based on the vehicle internal image, calculate a time to forward collision or a time to avoid forward collision with an object in front of a vehicle, and change a control time point of forward collision avoidance based on the forward attention level and the time to forward collision or the time to avoid forward collision.

19. The vehicle control device of claim 18, wherein the processor is configured to:
in response to the forward attention level being a first level, set the control time point of forward collision avoidance to a first time point; and
in response to the forward attention level being a second level lower than the first level, set the control time point of forward collision avoidance to a second time point before the first time point.

20. The vehicle control device of claim 18, wherein the processor is configured to change an output time point of an alert message for forward collision avoidance based on the forward attention level.
